(19) United States
(12) Patent Application Publication
(10) Pub. No.: US 2015/0027937 A1
(43) Pub. Date: Jan. 29, 2015

(54) SEAWATER DESALINATION SYSTEM

(71) Applicants: Akitomo Katou, Tokyo (JP); Masahiko Hoshino, Tokyo (JP); Koji Hiramoto, Tokyo (JP); Kazuhiko Fujise, Tokyo (JP)

(72) Inventors: Akitomo Katou, Tokyo (JP); Masahiko Hoshino, Tokyo (JP); Koji Hiramoto, Tokyo (JP); Kazuhiko Fujise, Tokyo (JP)

(73) Assignee: MITSUBISHI HEAVY INDUSTRIES, LTD., Tokyo (JP)

(21) Appl. No.: 14/378,882

(22) PCT Filed: Feb. 15, 2012
(86) PCT No.: PCT/JP2012/053577

§ 371 Date: Aug. 14, 2014

(51) Int. Cl. B01D 61/58; B01D 61/02; C02F 1/52; C02F 1/44; C02F 1/00; B01D 65/02

(52) U.S. Cl. CPC B01D 61/58; C02F 1/008; B01D 65/02; C02F 1/52; C02F 1/441; B01D 61/025; C02F 2103/08
USPC 210/149; 210/180; 210/177

(57) ABSTRACT

A seawater desalination system 10A includes a heat exchanging unit for heating feed seawater to a reverse osmosis membrane system using at least one or more of thermal discharge, exhaust gas, and steam generated through a gas engine and heating medium used in a heat pump system, and a reverse osmosis membrane system, provided in the downstream of the heat exchanging unit, for separating the feed seawater to the reverse osmosis membrane system into permeate and concentrate. The seawater desalination system according to the present invention is allowed to produce the permeate in economical and stable manners, even in such marine conditions as lower seawater temperature, by performing efficient heating and control of seawater.

### FIELD

The present invention relates to a seawater desalination system.

### BACKGROUND

In general, as one of the technical approaches for producing fresh water from seawater, a seawater desalination technology (hereafter referred to as a reverse osmosis membrane system) has been applied, in which pressurized seawater is fed to RO membranes (Reverse Osmosis Membranes) for dissolved salts removal from seawater.

The heating systems of feed seawater to the reverse osmosis membranes have been proposed to improve the recovery ratio of the reverse osmosis membranes (e.g., see Patent Literatures 1 and 2).

According to the Patent Literature 1, as the heating system of feed seawater to the reverse osmosis membranes, a steam heating system or a heat exchange system associated with oil-fired or coal-fired boilers is proposed.

In addition, according to the Patent Literature 2, the proposed desalination system integrates a heat exchanger, in which feed seawater to the membrane filters and rejected seawater from the membrane filters flow, so as to heat the feed seawater.

For another case, in an ultrapure water production system, a heat pump system is applied between a raw water tank and an ultrapure water production system to heat feed water by using waste heat of wastewater. (e.g., see Patent Literature 3).

### CITATION LIST

### Patent Literature

Patent Literature 1: Japanese Laid-open Patent Publication No. 11-267643

Patent Literature 2: Japanese Laid-open Patent Publication No. 2005-144301

Patent Literature 3: Japanese Laid-open Patent Publication No. 63-4808

### SUMMARY

### Technical Problem

In recent years, some projects have required a seawater desalination system even in such marine conditions as lower seawater temperature (e.g., below 5° C.) during a certain period of year. When seawater with lower than a certain temperature level (e.g., 5° C.) is intended to be desalinated, thermal desalination systems (e.g., a multistage flash technology, a multiple effect distillation technology, and a steam compression evaporation technology) are typically used.

In a reverse-osmosis-membrane-based seawater desalination system, pretreatment systems are typically provided in the upstream of the reverse osmosis membrane system. Since the performance of the pretreatment system is highly susceptible to feed seawater temperature, feed seawater temperature to the pretreatment systems is preferable to be kept over a certain temperature level (e.g., 5° C.).

As a result, when seawater with lower temperature is supplied to the pretreatment system without heating, the performance of the pretreatment system becomes considerably deteriorated. This suggests that feed seawater temperature to the pretreatment system is preferable to be heated over a certain temperature level (e.g., 5° C.).

When seawater with lower temperature is supplied to the reverse osmosis membrane system, the reverse osmosis membranes become physically hardened or frozen, which results in serious performance deterioration or fatal damage of the reverse osmosis membrane system. Once the reverse osmosis membranes become physically hardened or frozen, those membranes should be replaced with new ones as membrane permeability is difficult to be recovered.

Further, as feed seawater temperature to the reverse osmosis membrane system decreases, permeate capacity of the reverse osmosis membranes system reduces. To ensure required permeate capacity, feed pressure to the reverse osmosis membrane system should be raised. However, operating the reverse osmosis membranes under the high pressure condition promotes physical compaction of the reverse osmosis membranes. Particularly, the reverse osmosis membranes with irreversible physical compaction should be replaced with new ones as membrane permeability is difficult to be recovered.

As a result, when seawater with lower temperature is supplied to the reverse osmosis desalination system without heating, the performance of the reverse osmosis membrane system becomes considerably deteriorated. This suggests that feed seawater temperature to the reverse osmosis desalination system is preferable to be heated over a certain temperature level (e.g., 5° C.).

Some technical approaches for seawater heating have been proposed to solve above-mentioned challenges. A heating method described in Patent Literature 1 requires large amount of fuel consumption and large volume of fuel storage facilities, since steam generated from oil-fired or coal-fired boilers is used as heat sources. In addition, this approach is less cost-effectiveness and lower availability since the boilers work only when seawater temperature is under a certain level (e.g., 5° C.)

A heating method described in Patent Literature 2 uses a part of filtrate as heat sources. In such cases that feed water temperature is lower and large amounts of heat are required accordingly, this approach is difficult to provide sufficient amounts of heat for feed water heating by using only filtrate.

A heating method described in Patent Literature 3 focuses on the raw water within the temperature range from 5 to 20° C. In such cases that the raw water with lower temperature (e.g., 5° C.), this approach is not so feasible from the economical and operational viewpoints since larger heat pump capacity and higher electrical power consumption are required.

As stated above, these approaches described in Patent Literatures 1 to 3 are technically hard to produce fresh water (permeate) in economical and stable manners for reverse osmosis desalination of low-temperature seawater.

Thus, advanced reverse osmosis membrane systems to produce fresh water in economical and stable manners should be developed and commercialized, which is applicable to the marine conditions with lower seawater temperature (e.g., below 5° C.) by effective seawater heating and temperature control technologies.

The present invention takes into account technical challenges described above. The objective of the present invention is to provide a seawater desalination system for economical and stable fresh water production by efficient heating and control of seawater.

### Solution to Problem

To solve the above problems, according to a first invention of the present invention, a seawater desalination system includes: a heat exchanging unit for heating of feed seawater to the reverse osmosis membrane system using at least one or more of thermal discharge, exhaust gas, and steam generated through a gas engine and heating medium used for a heat pump system; and a reverse osmosis membrane system that is provided at the downstream of the heat exchanging unit and separates the feed seawater to the reverse osmosis membrane system into permeate and concentrate.

According to a second invention, in the seawater desalination system according to the first invention, the heat exchanging unit includes a first heat exchanger for performing heat exchange between the feed seawater to the reverse osmosis membrane system supplied via a first seawater branch line branched off from a seawater feed line for the reverse osmosis membrane system and the thermal discharge generated through the gas engine, and a third heat exchanger for performing heat exchange between a second heating medium exchanged heat with a cooling medium circulating through the heat pump system and the feed seawater to the reverse osmosis membrane system. The feed seawater to the reverse osmosis membrane system supplied via a second seawater branch line branched off from the seawater feed line is directly heated in the second seawater branch line by using the exhaust gas and the steam as heat sources, or indirectly heated by using a first heating medium exchanged heat with the exhaust gas and the steam. A first concentrate discharge line for supplying the concentrate to a fifth heat exchanger performing heat exchange between a third heating medium, exchanged heat with the cooling medium circulating through the heat pump system, and the concentrate, and then discharging the concentrate to the sea.

According to a third invention, in the seawater desalination system according to the first invention, the heat exchanging unit includes a first heat exchanger for performing heat exchange between the feed seawater to the reverse osmosis membrane system supplied via the first seawater branch line branched off from the seawater feed line for the feed seawater to the reverse osmosis membrane system and the thermal discharge generated through the gas engine, and the third heat exchanger for performing heat exchange between the second heating medium exchanged heat with a cooling medium circulating through the heat pump system and the feed seawater to the reverse osmosis membrane system. The feed seawater to the reverse osmosis membrane system supplied via the second seawater branch line branched off from the seawater feed line is directly heated in the second seawater branch line by using the exhaust gas and the steam as heat sources, or indirectly heated by using the first heating medium exchanged heat with the exhaust gas and the steam. The system further includes: a seawater feed line for supplying feed seawater to the fifth heat exchanger; a seawater extraction line for extracting the feed seawater to the reverse osmosis membrane system from the upstream of the heat exchanging unit and supplying the extracted feed seawater to the reverse osmosis membrane system to the downstream of the heat exchanging unit; and a sixth heat exchanger for performing heat exchange between the feed seawater to the reverse osmosis membrane system extracted into the seawater extraction line and the concentrate in a second concentrate discharge line for discharging the concentrate from the reverse osmosis membrane system to the sea.

According to a fourth invention, in the seawater desalination system according to the third invention, the second concentrate discharge line and the seawater supply line to the heat exchanging unit are connected.

According to a fifth invention, the seawater desalination system according to any one of the first to forth inventions further includes: a pretreatment system for removal of suspended matters contained in the feed seawater to the reverse osmosis membrane system, the pretreatment system being provided in the upstream or the downstream of the heat exchanging unit; switching valves for switching a feed seawater stream feed seawater to the reverse osmosis membrane system and temperature controllers for measuring temperature of the feed seawater to the reverse osmosis membrane system to control the switching valves, the switching valves and the temperature controllers being installed in either of, or both of, a section between the heat exchanging unit and the pretreatment system and a section in the downstream of the pretreatment system and the heat exchanging unit but in the upstream of the reverse osmosis membrane system. According to temperature of the feed seawater to the reverse osmosis membrane system, the temperature controllers control the switching valves to switch a feed seawater stream to the reverse osmosis membrane system.

According to a sixth invention, the seawater desalination system according to any one of the first to forth inventions further includes switching valves for switching a concentrate stream and temperature controllers for measuring temperature of the concentrate to control the switching valves. According to temperature of the concentrate, the temperature controllers control the switching valves to switch a concentrate stream.

According to a seventh invention, the seawater desalination system according to any one of the first to forth inventions further includes a cleaning unit for cleaning reverse osmosis membranes in the reverse osmosis membrane system. The cleaning unit is provided in the downstream of the reverse osmosis membrane system. The cleaning unit includes a permeate tank for storing the permeate, cleaning pumps for supplying the permeate in the permeate tank to the reverse osmosis membranes of the reverse osmosis membrane system, a heating unit for heating the permeate in the permeate tank, and a temperature controller for measuring temperature of the permeate in the permeate tank to control the heating unit, and according to temperature of the permeate in the permeate tank, the temperature controller controls the heating unit to heat the permeate or control the cleaning pumps to supply the permeate to the reverse osmosis membrane system.

According to an eighth invention, the seawater desalination system according to any one of the first to forth inventions further includes a coagulant and/or flocculant injection unit for supplying chemicals to coagulate suspended matters contained in the feed seawater to the reverse osmosis membrane system, the coagulant and/or flocculant injection unit being provided in the upstream of the pretreatment system.

According to a ninth invention, in the seawater desalination system according to any one of the first to forth inventions, the heat exchanging unit heats the feed seawater to the reverse osmosis membrane system to be over a range from 5° C. to 30° C.

### Advantageous Effects of Invention

The seawater desalination system of the present invention allows fresh water (permeate) production in economical and stable manners by efficient heating and control of seawater, even in such marine conditions as lower seawater temperature.

### BRIEF DESCRIPTION OF DRAWINGS

FIG. 1 is a block diagram of a seawater desalination system according to a first embodiment of the present invention.

FIG. 2 is a block diagram of a heat pump system according to the first embodiment.

FIG. 3 illustrates an example of alternative configuration of switching valves.

FIG. 4 is a block diagram of a seawater desalination system according to a second embodiment of the present invention.

FIG. 5 is a block diagram of a seawater desalination system according to a third embodiment of the present invention.

FIG. 6 is a block diagram of a seawater desalination system according to a fourth embodiment of the present invention.

FIG. 7 is a block diagram of another seawater desalination system according to the fourth embodiment of the present invention.

FIG. 8 is a block diagram of another seawater desalination system according to the fourth embodiment of the present invention.

FIG. 9 is a block diagram of a seawater desalination system according to a fifth embodiment of the present invention.

FIG. 10 is a block diagram of another seawater desalination system according to the fifth embodiment of the present invention.

FIG. 11 is a block diagram of another seawater desalination system according to the fifth embodiment of the present invention.

FIG. 12 is a block diagram of another seawater desalination system according to the fifth embodiment of the present invention.

FIG. 13 is a block diagram of another seawater desalination system according to the fifth embodiment of the present invention.

FIG. 14 is a block diagram of another seawater desalination system according to the fifth embodiment of the present invention.

### DESCRIPTION OF EMBODIMENTS

### First Embodiment

### Seawater Desalination System

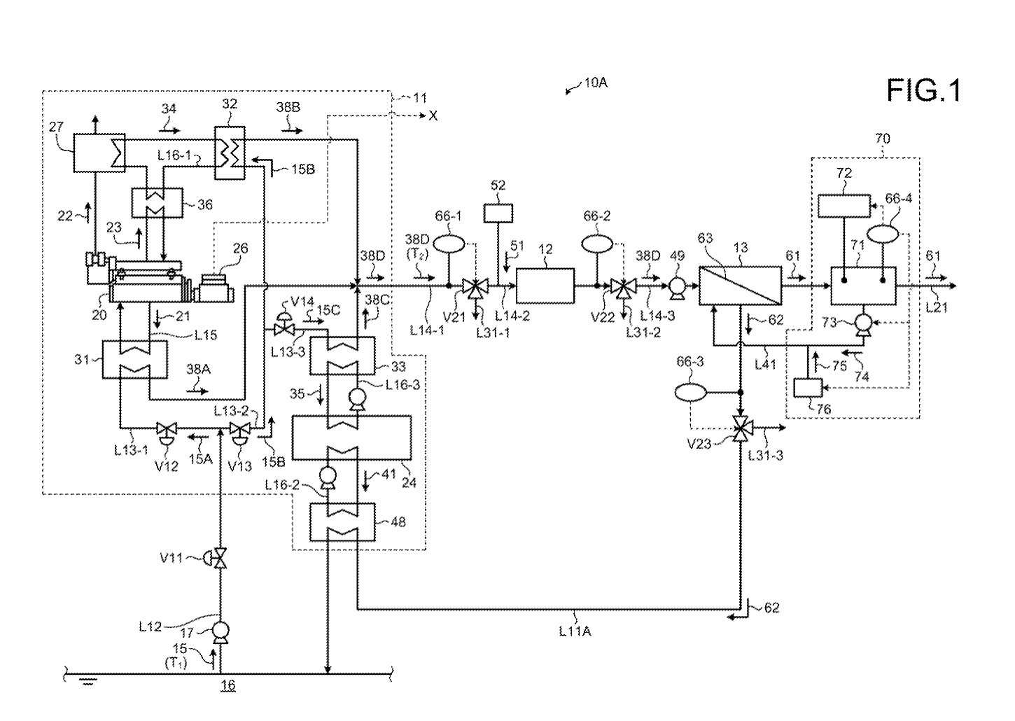

A first embodiment of the seawater desalination system according to a first embodiment of the present invention will be described referring to the attached drawings. FIG. 1 is a block diagram of a seawater desalination system according to the embodiment. As illustrated in FIG. 1, the seawater desalination system 10A according to the embodiment includes a heat exchanging unit 11, a pretreatment system 12, a reverse osmosis membrane system 13, and a first concentrate discharge line L11A.

Feed seawater 15 to the reverse osmosis membrane system is supplied from the sea 16 to the heat exchanging unit 11, passing through a seawater supply line L12, by the pump 17. To control the flow rate of the feed seawater 15 to the reverse osmosis membrane system, a control valve V11 is provided in the seawater supply line L12.

[Heat Exchanging Unit]

The heat exchanging unit 11 is provided in the upstream of the pretreatment system 12, and heats the feed seawater 15 to the reverse osmosis membrane system using one or more of thermal discharge 21, exhaust gas 22, and steam 23 generated through a gas engine 20 and a second heating medium 35 used in a heat pump system 24.

The heat exchanging unit 11 includes a first heat exchanger 31, a second heat exchanger 32, a third heat exchanger 33, a fourth heat exchanger 36, and an exhaust gas boiler 27.

The first heat exchanger 31 performs heat exchange between the feed seawater 15A to the reverse osmosis membrane system supplied via a first seawater branch line L13-1 branched off from the seawater supply line L12 for supplying the feed seawater 15 to the reverse osmosis membrane system to the reverse osmosis membrane system 13 and the thermal discharge 21 generated through the gas engine 20.

The second heat exchanger 32 performs heat exchange between the feed seawater 15B to the reverse osmosis membrane system supplied via a second seawater branch line L13-2 branched off from the seawater supply line L12 and a first heating medium 34 that is heated by exchanging heat with the exhaust gas 22 and the steam 23 generated through the gas engine 20.

The third heat exchanger 33 performs heat exchange between a second heating medium 35 that exchanged heat with a cooling medium 47 circulating in the heat pump system 24 and the feed seawater 15C to the reverse osmosis membrane system supplied via a third seawater branch line L13-3 branched off from the second seawater branch line L13-2.

The fourth heat exchanger 36 performs heat exchange between the steam 23 generated through the gas engine 20 and the first heating medium 34. The 27 performs heat exchange between the exhaust gas 22 generated through the gas engine 20 and the first heating medium 34.

(Gas Engine)

The gas engine 20 produces electric power by a generator 26 using the thermal energy produced by the burning of fuel gas. The electric power by power generation is supplied for the operation of each component in the seawater desalination system 10A. The fuel gas is a combustible gas including hydrocarbon or the like. The flue gas 22 generated through the gas engine 20 is supplied to the exhaust heat boiler 27. The steam 23 generated through the gas engine 20 is supplied to the fourth heat exchanger 36. Cooling water for shaft cooling of the gas engine 20 is discharged as the thermal discharge 21 to a drainage circulation line L15, and exchanges heat with the feed seawater 15A to the reverse osmosis membrane system in the first heat exchanger 31. Note that, the embodiment includes only one gas engine 20, however, it is not limited to the configuration, and may be configured to include multiple gas engines as required. Further, in the embodiment, the gas engine 20 is provided as an example, however, it is not limited to the gas engine 20. Any other systems producing power and heat (e.g., thermal discharge, steam, exhaust gas) may be used. For example, other internal combustion engines including a gas turbine or the like, may be used.

The steam 23 generated through the gas engine 20 exchanges heat with the first heating medium 34 circulated via a heating medium circulation line L16-1, in the fourth heat exchanger 36. The first heating medium 34 circulates through the exhaust gas boiler 27, the second heat exchanger 32, and the fourth heat exchanger 36, via the heating medium circulation line L16-1.

The exhaust gas 22 generated through the gas engine 20 exchanges heat with the first heating medium 34 in the exhaust gas boiler 27. The first heating medium 34 which has exchanged heat in the fourth heat exchanger 36 exchanges heat with the exhaust gas 22 in the exhaust gas boiler 27, and is then supplied to the second heat exchanger 32.

The first seawater branch line L13-1 and the second seawater branch line L13-2 are provided to branch off from the seawater supply line L12. The third seawater branch line L13-3 is provided to branch off from the second seawater branch line L13-2. The first to third seawater branch lines L13-1 to L13-3 are connected with a heated seawater supply line L14-1.

The feed seawater 15 to reverse osmosis membrane system supplied to the heat exchanging unit 11 via the seawater supply line L12, that is, the feed seawater 15A to the reverse osmosis membrane system is supplied to the first heat exchanger 31 via the first seawater branch line L13-1, and the feed seawater 15B to the reverse osmosis membrane system is supplied to the second heat exchanger 32 via the second seawater branch line L13-2. A part of the feed seawater 15B to the reverse osmosis membrane system, that is, the feed seawater 15C to the reverse osmosis membrane system is supplied to the third heat exchanger 33 via the third seawater branch line L13-3. Control valves V12 to V14 are provided on first to third seawater branch lines L13-1 to L13-3 to control each flow rate of the feed seawater 15A to the reverse osmosis membrane system, the feed seawater 15B to the reverse osmosis membrane system, and the feed seawater 15C to the reverse osmosis membrane system supplied to each line.

The feed seawater 15A to the reverse osmosis membrane system supplied to the first heat exchanger 31 via the first seawater branch line L13-1 is heated, in the first heat exchanger 31, by exchanging heat with the thermal discharge 21 generated through the gas engine 20.

The feed seawater 15B to the reverse osmosis membrane system supplied to the second heat exchanger 32 via the second seawater branch line L13-2 is heated, in the second heat exchanger 32, by exchanging heat with the first heating medium 34 circulating in the heating medium circulation line L16-1.

In this manner, the first heating medium 34 is heated in the exhaust gas boiler 27 and the fourth heat exchanger 36 by exchanging heat with the exhaust gas 22 and the steam 23, and then supplied to the second heat exchanger 32 to heat the feed seawater 15B to the reverse osmosis membrane system, which is supplied to the second heat exchanger 32 via the second seawater branch line L13-2, by exchanging heat with the feed seawater 15B to the reverse osmosis membrane system.

The feed seawater 15A to the reverse osmosis membrane system is heated in the first heat exchanger 31, then supplied to heated seawater supply lines L14-1 and L14-2 via the first seawater branch line L13-1 as heated seawater 38A, and then supplied to the pretreatment system 12. The feed seawater 15B to the reverse osmosis membrane system is heated in the second heat exchanger 32, then supplied to the heated seawater supply lines L14-1 and L14-2 via the second seawater branch line L13-2 as heated seawater 38B, and then supplied to the pretreatment system 12.

(Heat Pump System)

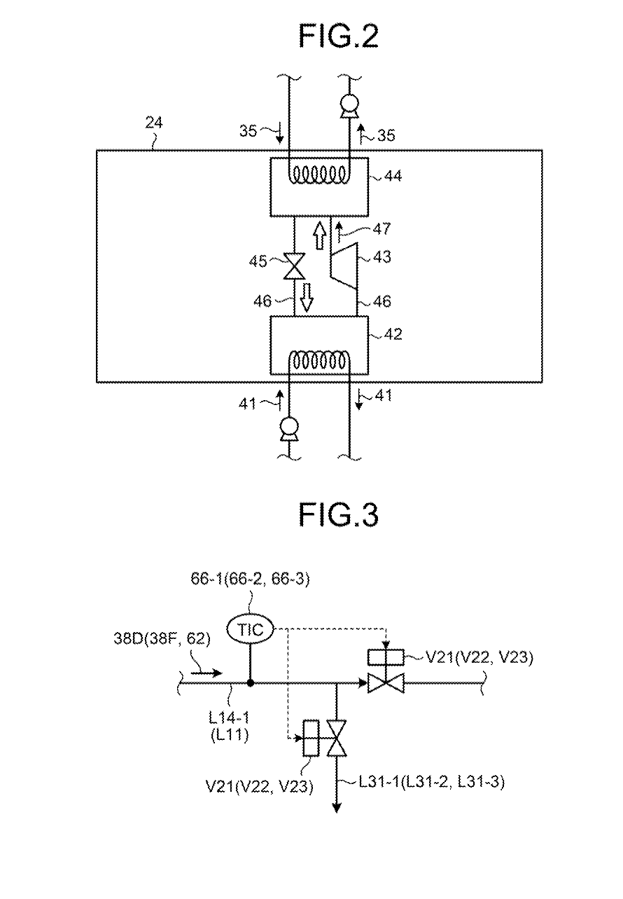

The heat pump system 24 heats the second heating medium 35 by using the third heating medium 41. The configuration of the heat pump system 24 is illustrated in FIG. 2. As illustrated in FIG. 2, the heat pump system 24 includes an evaporator 42, a compressor 43, a condenser 44, and an expansion valve 45 connected through piping 46. Note that, the embodiment includes only one heat pump system 24. However, it is not limited to the configuration, and multiple heat pump systems may be provided as required.

The evaporator 42 evaporates the cooling medium 47 by using the third heating medium 41. The third heating medium 41 circulates through the evaporator 42 and the fifth heat exchanger 48 via the heating medium circulation line L16-2. The third heating medium 41 is circulated by a pump.

The compressor 43 compresses the cooling medium, and supplies the cooling medium to the condenser 44. A positive displacement type, a centrifugal type, or the like are applicable as mechanical types of the compressor 43. An on-off control mechanism, an operational number control mechanism, a RPM (revolutions per minute) control mechanism, or the like are applicable as the capacity control mechanism of the compressor 43. Note that, the embodiment includes only one compressor 43. However, it is not limited to the configuration, and multiple compressors may be provided as required.

The condenser 44 condenses the cooling medium 47 by using the second heating medium 35. The second heating medium 35 circulates through the condenser 44 and the third heat exchanger 33 via the heating medium circulation line L16-3. The second heating medium 35 is circulated by a pump.

The expansion valve 45 controls the flow rate and the pressure of the cooling medium 47 circulating through the evaporator 42 and the condenser 44.

In the heat pump system 24, first, the cooling medium 47 is compressed by the compressor 43, and then supplied to the condenser 44 under the high pressure condition. Then, the cooling medium 47 exchanges heat with the second heating medium 35 in the condenser 44, dissipating heat by condensation. In this manner, the second heating medium 35 is heated. Then the cooling medium 47 is supplied to the evaporator 42 via the expansion valve 45 to exchange heat with the third heating medium 41 in the evaporator 42. Thereby, the cooling medium 47 evaporates and absorbs heat from the third heating medium 41. Then, the cooling medium 47 is supplied to the compressor 43 and circulates, thereby continuously heating the second heating medium 35.

The concentrate 62 separated by the reverse osmosis membrane system 13 is supplied to the fifth heat exchanger 48 via the first concentrate discharge line L11A. The third heating medium 41 exchanges heat with the concentrate 62 in the fifth heat exchanger 48, and then exchanges heat with the cooling medium 47 in the evaporator 42 in the heat pump system 24. The second heating medium 35 heated in the condenser 44 in the heat pump system 24 exchanges heat with the feed seawater 15C to the reverse osmosis membrane system supplied to the third heat exchanger 33.

The feed seawater 15C to the reverse osmosis membrane system is supplied to the third heat exchanger 33 via the third seawater branch line L13-3 to exchange heat with the second heating medium 35 in the third heat exchanger 33.

After heating in the third heat exchanger 33, the feed seawater to the reverse osmosis membrane system 15C is supplied to the heated seawater supply lines L14-1 and L14-2 via the third seawater branch line L13-3 as heated seawater 38C, and then supplied to the pretreatment system 12.

The heated seawater 38A to 38C at a certain temperature level (e.g., 5° C.) is supplied to the pretreatment system 12 as heated seawater 38D via the heated seawater supply lines L14-1 and L14-2.

In this manner, in the heat exchanging unit 11, feed seawater 15A and 15B to the reverse osmosis membrane system are heated in the first heat exchanger 31 and the second heat exchanger 32 by using the thermal discharge 21, the exhaust gas 22, and the steam 23 discharged by the gas engine 20, and also, the feed seawater 15C to the reverse osmosis membrane system is heated by the third heat exchanger 33 and the fifth heat exchanger 48. As a result, even when the temperature of the feed seawater 15 to the reverse osmosis membrane system is lower than a certain temperature level (e.g., 5° C.), the feed seawater to the reverse osmosis membrane system 15 can be supplied to the pretreatment system 12 and the reverse osmosis membrane system 13 after preheating up to a proper temperature level for operating the pretreatment system 12 and the reverse osmosis membrane system 13.

When higher operational temperature is set, feed pressure of seawater to the reverse osmosis membrane system 13 will be reduced but energy consumption for heating will increase. When lower operational temperature is set, energy consumption for heating will be reduced but feed pressure of seawater to the reverse osmosis membrane system 13 will increase. As described above, a trade-off relationship is developed between energy consumption for heating and feed pressure of seawater to the reverse osmosis membrane system 13. This suggests that the operational temperature can be optimized.

The operational temperature is preferably in the range from 5° C. to 30° C., more preferably, from 5° C. to 15° C., and furthermore preferably, from 5° C. to 10° C. The most preferable value of the operational temperature is 5° C. The operational temperature is determined project by project, as the operational temperature range depends on the environmental conditions where the pretreatment system 12 and the reverse osmosis membrane system 13 are installed.

The heat exchanging unit 11 can raise the temperature (T₁) of the feed seawater to the reverse osmosis membrane system 15 supplied to the seawater supply line L12 up to the temperature (T₂) of the heated seawater 38D. The temperature T₂ should have the minimum temperature which does not bring about performance degradation of the pretreatment system 12 and the reverse osmosis membrane system 13. The temperature T₂ is preferably in the range from 5° C. to 30° C., more preferably, from 5° C. to 15° C., and furthermore preferably, from 5° C. to 10° C. The most preferable value of the temperature T₂ is around 5° C. When T₁ is lower than a certain temperature level (e.g., 5° C.), the heat exchanging unit 11 heats the feed seawater to the reverse osmosis membrane system 15 up to T₂, a certain temperature level (e.g., 5° C.). Note that, the temperature range is determined project by project, as the temperature range which does not bring about performance degradation of the pretreatment system 12 and the reverse osmosis membrane system 13 depends on environmental conditions where the pretreatment system 12 and the reverse osmosis membrane system 13 are installed.

In the embodiment, the heat exchanging unit 11 is integrated with both the gas engine 20 and the heat pump system 24 as heating sources. However, the embodiment is not limited to the configuration, and the heat exchanging unit 11 may use either the gas engine 20 or the heat pump system 24 as heating sources.

A coagulant and/or flocculant injection unit 52 for supplying a coagulant and/or flocculant 51 to the heated seawater 38D is provided in the heated seawater supply line L14-1 in the upstream of the pretreatment system 12. By injecting the coagulant and/or flocculant 51 to the heated seawater 38D by the coagulant and/or flocculant injection unit 52, the coagulation of suspended matters contained in the heated seawater 38D (feed seawater to the reverse osmosis membrane system 15) is promoted.

In this manner, in the pretreatment system 12, the suspended matters contained in the heated seawater 38D can be removed.

Typically known coagulants and flocculants may be used as the coagulant and flocculant 51, for example, iron-based inorganic coagulants such as ferric chloride (FeCl₃) and ferric sulfate (Fe₂(SO₄)₃), aluminum-based inorganic coagulants such as aluminum sulfate (Al₂(SO₄)₃) and polychlorinated aluminum (PAC), and polyelectrolyte flocculants such as polyacrylamide-based flocculants or the like. As a coagulant aid, for example, activated silica or sodium alginate may be used.

In the embodiment, the coagulant and/or flocculant injection unit 52 is provided. However, it is not limited to the configuration, and the coagulant and/or flocculant injection unit 52 may not be provided.

[Pretreatment System]

From the pretreatment system 12, the heated seawater 38D (feed seawater 15 to the reverse osmosis membrane system) is supplied to the reverse osmosis membrane system 13 via the heated seawater supply line L14-3. The suspended matters contained in the heated seawater 38D are removed in the pretreatment system 12. The type of the pretreatment system 12 may be, for example, a coagulating sedimentation technology, a sand filtration technology, a membrane filtration technology, and a dissolved air flotation technology. One of these technologies or a combination of these technologies may be used in the pretreatment system 12.

After removing the suspended matters from the heated seawater 38D in the pretreatment system 12, the heated seawater 38D is pressurized by a booster pump 49 and supplied to the reverse osmosis membrane system 13 via the heated seawater supply line L14-3.

[Reverse Osmosis Membrane System]

In the reverse osmosis membrane system 13, the heated seawater 38D (feed seawater 15 to the reverse osmosis membrane system) is separated into the permeate (fresh water) 61 and the concentrate 62. The reverse osmosis membrane system 13 is a desalination system applying a reverse-osmosis-membrane-based technology, including reverse osmosis membranes 63. In the reverse osmosis membrane system 13, the pressurized heated seawater 38D is fed to the reverse osmosis membrane 63 so that dissolved salts in the heated seawater 38D can be removed and permeate 61 is produced.

The embodiment includes only one train of the reverse osmosis membrane system 13. However, it is not limited to the configuration, and multiple trains may be provided as required. Further, the embodiment includes only one stage of the reverse osmosis membrane system 13. However, it is not limited to the configuration, and multiple stages may be provided as required.

The reverse osmosis membrane system 13 consists of, for example, a reverse osmosis membrane module which reverse osmosis elements are incorporated into a pressure vessel. The reverse osmosis membrane 63 is a separation membrane which rejects a solute and allows only a solvent to be permeated. The heated seawater 38D is pressurized by the booster pump 49 to have a pressure as high as, or above, the osmotic pressure, and then supplied to the reverse osmosis membrane system 13 to be separated into the permeate 61 and the concentrate 62. In this manner, the permeate 61 is produced.

The type of the reverse osmosis membrane may be a spiral wound membrane or a hollow fiber membrane. The material of the reverse osmosis membrane may be polyamide-based compounds or cellulose-based compounds.

The permeate 61 is supplied to external facilities for water users via the permeate line L21. The concentrate 62 is discharged via the first concentrate discharge line L11A.

The first concentrate discharge line L11A is connected to the fifth heat exchanger 48 for performing heat exchange between the third heating medium 41 which exchanged heat with the cooling medium 47 circulating in the heat pump system 24 and the concentrate 62. Through the first concentrate discharge line L11A, the concentrate 62 is supplied to the fifth heat exchanger 48 and then discharged to the sea 16. The concentrate 62 is supplied to the fifth heat exchanger 48 via the first concentrate discharge line L11A to exchange heat with the third heating medium 41 in the fifth heat exchanger 48, and then discharged to the sea 16.

In this manner, the seawater desalination system 10A according to the embodiment heats the feed seawater 15 to the reverse osmosis membrane system in the heat exchanging unit 11, by using the thermal energy of the thermal discharge, the steam, and the exhaust gas generated through the gas engine 20 as external heat sources for heating the feed seawater 15 to the reverse osmosis membrane system. When the temperature of the feed seawater 15 to the reverse osmosis membrane system is lower than a certain level (e.g., 5° C.), the total required amount of thermal energy for heating the feed seawater 15 to the reverse osmosis membrane system can be covered by combined operation of the gas engine 20 and the heat pump system 24. Further, the electric power by power generation of the gas engine 20 can be used for operating the seawater desalination system 10A.

The seawater desalination system 10A according to the embodiment is economically and stably allowed to produce fresh water (permeate) by efficient heating and control of the seawater, as described below. (1) In the method described in Patent Literature 1 in which seawater is heated by steam of a boiler, this method has less technical flexibility for process design. On the other hand, the sweater desalination system 10A according to the embodiment applies the method for heating feed seawater 15 to the reverse osmosis membrane system in the heat exchanging unit 11, by using the thermal energy of the thermal discharge, the steam, and the exhaust gas generated through the gas engine 20, and by using the thermal energy of low-temperature concentrate 62 recovered from the heat pump system 24. For this reason, other than the seawater desalination system 10A according to the embodiment, the variety of process design is applicable to heating methods of the feed seawater 15 to the reverse osmosis membrane system, according to second to fifth embodiments of seawater desalination systems described below. Consequently, the embodiment is allowed to provide an optimum seawater desalination system in compliance with site constraints, environmental conditions, or the like where the seawater desalination system is installed.

(2) In the method described in Patent Literature 1 for heating seawater by steam of a boiler, huge fuel storage facilities should be provided due to heavy consumption of fossil fuels. On the other hand, the sweater desalination system 10A according to the embodiment applies the method for heating feed seawater 15 to the reverse osmosis membrane system in the heat exchanging unit 11, by using the thermal energy of the thermal discharge, the steam, and the exhaust gas generated through the gas engine 20, and by using the thermal energy of low-temperature concentrate 62 recovered from the heat pump system 24. For this reason, the seawater desalination system 10A according to the embodiment is allowed to reduce the capacity of fossil fuel storage facilities and make the facilities arrangement compactor. Consequently, the embodiment can provide the seawater desalination system with less susceptible to the site constraints.

(3) In the method described in Patent Literature 1 for heating seawater by steam of a boiler, higher operational cost is spent during the medium-to-long-term operational services due to heavy consumption of fossil fuels. On the other hand, the sweater desalination system 10A according to the embodiment applies the method for heating feed seawater 15 to the reverse osmosis membrane system in the heat exchanging unit 11, by using the thermal energy of the thermal discharge, the steam, and the exhaust gas generated through the gas engine 20, and by using the thermal energy of low-temperature concentrate 62 recovered from the heat pump system 24. Consequently, the embodiment is allowed to reduce fossil fuel consumption, lower the operational cost and life cycle cost, and thereby provide a cost-effective seawater desalination system.

(4) In the method described in Patent Literature 1 for heating seawater by steam of a boiler, the method is susceptible to social and economic conditions due to heavy consumption of fossil fuels. On the other hand, the sweater desalination system 10A according to the embodiment applies the method for heating feed seawater 15 to the reverse osmosis membrane system in the heat exchanging unit 11, by using the thermal energy of the thermal discharge, the steam, and the exhaust gas generated through the gas engine 20, and by using the thermal energy of low-temperature concentrate 62 recovered from the heat pump system 24. Consequently, the embodiment is allowed to mitigate the effect of such social and economic conditions, and thereby provide a robust seawater desalination system in relation to the fluctuation of external factors including social and economic conditions.

As described above, the seawater desalination system 10A according to the embodiment is allowed to produce permeate 61 in economical and stable manners, by means of effective heating and control of the feed seawater 15 to the reverse osmosis membrane system. The seawater desalination system 10A according to the embodiment includes the heat exchanging unit 11, the pretreatment system 12, the reverse osmosis membrane system 13, and the first concentrate discharge line L11A. The seawater desalination system 10A according to the embodiment includes the heat exchanging unit 11 which performs heat exchange of the feed seawater 15A and 15B to the reverse osmosis membrane system in the first heat exchanger 31, the second heat exchanger 32, the fourth heat exchanger 36, and the exhaust gas boiler 27, by using the thermal discharge 21, the exhaust gas 22, and the steam 23 generated through the gas engine 20. Further, the concentrate 62 separated in the reverse osmosis membrane system 13 exchanges heat with the third heating medium 41 in the fifth heat exchanger 48, and the feed seawater 15C to reverse osmosis membrane system exchanges heat with the second heating medium 35 in the third heat exchanger 33 via the heat pump system 24.

In this manner, as a result, even when the temperature of the feed seawater 15 to reverse osmosis membrane system is lower than a certain temperature level (e.g., 5° C.), the feed seawater 15 to the reverse osmosis membrane system can be supplied to the pretreatment system 12 after preheating over a certain temperature level (e.g., above 5° C.). Therefore, the seawater desalination system 10A according to the embodiment can provide pretreatment operation in economical and stable manners, even in such marine conditions as lower seawater temperature, by efficient heating and control of the seawater. Further, even when the temperature of the feed seawater 15 to the reverse osmosis membrane system is lower than a certain temperature level (e.g., 5° C.), the feed seawater 15 to the reverse osmosis membrane system can be heated over a certain temperature level (e.g., 5° C.) and then supplied to the reverse osmosis membrane system 13. Consequently, the seawater desalination system 10A according to the embodiment is allowed to produce permeate 61 in economical and stable manners, even in such marine conditions as lower seawater temperature, by efficient heating and control of the seawater.

(Control of Streams)

The control of streams of the heated seawater 38D and the concentrate 62 will be described. In the heated seawater supply line L14-1 arranged between the heat exchanging unit 11 and the pretreatment system 12, a switching valve V21 for switching the stream of the heated seawater 38D (feed seawater 15 to the reverse osmosis membrane system) and a temperature controller 66-1 for measuring the temperature of the heated seawater 38D (feed seawater 15 to the reverse osmosis membrane system 15) to control the switching valve V21 are provided. In the heated seawater supply line L14-3 arranged between the pretreatment system 12 and the reverse osmosis membrane system 13, a switching valve V22 and a temperature controller 66-2 are provided. The switching valves V21 and V22 ensure the automatic changeover of the streams of the heated seawater supply lines L14-1 and L14-3 by control of the temperature controllers 66-1 and 66-2. Note that, either set of the switching valve V21 and the temperature controller 66-1 between the heat exchanging unit 11 and the pretreatment system 12, or the switching valve V22 and the temperature controller 66-2 between the pretreatment system 12 and the reverse osmosis membrane system 13, may be provided.

When the temperature of the heated seawater 38D measured by the temperature controller 66-1 is lower than a certain temperature level (e.g., 5° C.), the switching valve V21 automatically switches the stream so that the heated seawater 38D can be discharged outside the process via the seawater discharge line L13-1. When the temperature of the heated seawater 38D measured by the temperature controller 66-1 is higher than a certain temperature level (e.g., 5° C.), the switching valve V21 automatically switches the stream so that the heated seawater 38D can be supplied to the pretreatment system 12 via the heated seawater supply line L14-2.

That is, the temperature controller 66-1 and the switching valve V21 in the heated seawater supply line L14-1 are allowed to switch the stream of the heated seawater 38D so as not to be supplied to the pretreatment system 12, when the temperature of the heated seawater 38D supplied to the pretreatment system 12 is lower than a certain temperature level (e.g., 5° C.) For this reason, performance decline of the pretreatment system 12 is prevented. Since the heated seawater 38D is supplied to the pretreatment system 12 when the temperature of the heated seawater 38D supplied to the pretreatment system 12 is higher than a certain temperature level (e.g., 5° C.), performance decline of both the pretreatment system 12 and the downstream reverse osmosis membrane system 13 is prevented. As a result, the stream switching of the heated seawater 38D according to the temperature of the heated seawater 38D by the temperature controller 66-1 allows stable operation of the pretreatment system 12.

When the temperature of the heated seawater 38D measured by the temperature controller 66-2 is lower than a certain temperature level (e.g., 5° C.), the switching valve V22 automatically switches the stream so that the heated seawater 38D can be discharged outside the process via the seawater discharge line L13-2. When the temperature of the heated seawater 38D measured by the temperature controller 66-2 is higher than a certain temperature level (e.g., 5° C.), the switching valve V21 automatically switches the stream so that the heated seawater 38D can be supplied to the reverse osmosis membrane system 13 via the heated seawater supply line L14-3.

That is, the temperature controller 66-2 and the switching valve V22 in the heated seawater supply line L14-3 are allowed to switch the stream of the heated seawater 38D so as not to be supplied to the reverse osmosis membrane system 13, when the temperature of the heated seawater 38D supplied to the reverse osmosis membrane system 13 is lower than a certain temperature level (e.g., 5° C.). Thereby, performance decline of the reverse osmosis membrane system 13 is prevented. Since the heated seawater 38D is supplied to the reverse osmosis membrane system 13 when the temperature of the heated seawater 38D supplied to the reverse osmosis membrane system 13 is higher than a certain temperature level (e.g., 5° C.), performance decline of the reverse osmosis membrane system 13 is prevented. As a result, the stream switching of the heated seawater 38D according to the temperature of the heated seawater 38D by the temperature controller 66-2 allows stable operation of the reverse osmosis membrane system 12.

In the first concentrate discharge line L11A and the second concentrate discharge lines L11B and L11C for discharging the concentrate 62 from the reverse osmosis membrane system 13, a switching valve V23 for switching the stream of the concentrate 62 and a temperature controller 66-3 for measuring the temperature of the concentrate 62 to control the switching valve are provided. The switching valve V23 is an automatic valve switching the stream of the concentrate 62, by control of the temperature controller 66-3. The temperature controller 66-3 measures the temperature of the concentrated water 62 and controls the switching valve V23 to switch the stream of the concentrate 62 according to the temperature of the concentrate 62.

When the temperature of the concentrate 62 measured by the temperature controller 66-3 is lower than a certain temperature level (e.g., 5° C.), the switching valve V23 automatically switches the stream so that the concentrate 62 is discharged outside the process via the concentrate discharge line L31-3. When the temperature of the concentrate 62 measured by the temperature controller 66-3 is higher than a certain temperature level (e.g., 5° C.), the switching valve V21 automatically switches the stream so that the concentrate 62 can be supplied to the fifth heat exchanger via the concentrate discharge line L31-3.

That is, the temperature controller 66-3 and the switching valve V23 in the first concentrate discharge line L11A are allowed to switch the stream of the concentrate 62 so as not to be supplied to the fifth heat exchanger 48, when the temperature of the concentrate 62 supplied to the fifth heat exchanger 48 is lower than a certain temperature level (e.g., 5° C.). Thereby, heat exchanging performance decline of the fifth heat exchanger 48 is prevented. When the temperature of the concentrate 62 supplied to the fifth heat exchanger 48 is higher than a certain temperature level (e.g., 5° C.), the concentrate 62 is supplied to the fifth heat exchanger 48, so that sufficient heat exchanging performance of the fifth heat exchanger 48 can be given. As a result, the stream switching of the first concentrate discharge line L11A according to the temperature of the concentrate 62 by the temperature controller 66-3 allows stable operation of the fifth heat exchanger 48.

The embodiment provides three-way valves as switching valves V21 to V23. However, it is not limited to the configuration. An example of alternative configurations of the switching valve is illustrated in FIG. 3. As illustrated in FIG. 3, instead of one set of three-way valve, two sets of two-way valves controlled and switched by the temperature controllers 66-1 to 66-3 may be provided.

In the embodiment, the description is made for the seawater desalination system 10A including the temperature controllers 66-1 to 66-3 and the switching valves V21 to V23. However, it is not limited to the configuration. At least one or more of the sets of the temperature controller 66-1 and the switching valve V21, the temperature controller 66-2 and the switching valve V22, and the temperature controller 66-3 and the switching valve V23 may be provided. Further, none of the temperature controllers 66-1 to 66-3 and the switching valves V21 to V23 may be provided.

(Cleaning of Reverse Osmosis Membranes)

Cleaning of the reverse osmosis membranes 63 will be described. A cleaning unit 70 for cleaning the reverse osmosis membranes 63 of the reverse osmosis membrane system 13 is provided in the permeate line L21 which is in the downstream of the reverse osmosis membrane system 13. The cleaning unit 70 includes a permeate tank 71, a heating unit 72, a cleaning pump 73, and a temperature controller 66-4. The permeate tank 71 stores the permeate 61 produced by the reverse osmosis membrane system 13. The heating unit 72 heats the permeate 61 in the permeate tank 71 to a certain temperature level (e.g., 5° C. or higher). The heating unit 72 is not particularly limited, and for example, heaters may be used. The cleaning pump 73 supplies the permeate 61 in the permeate tank 71 to the reverse osmosis membranes 63 of the reverse osmosis membrane system 13. The temperature controller 66-4 measures the temperature of the permeate 61 in the permeate tank 71. According to the measured temperature, the temperature controller 66-4 controls the heating unit 72 to heat the permeate 61, or controls the cleaning pump 73 to supply the permeate 61 to the reverse osmosis membrane system 13 as cleaning water 74.

When the reverse osmosis membrane system 13 is to be cleaned, the temperature controller 66-4 is responsible for the cleaning of the reverse osmosis membranes 63, that is, for supplying a part of the permeate 61 in the permeate tank 71 as cleaning water 74 to the reverse osmosis membrane system 13, via the cleaning water supply line L41 by the cleaning pump 73.

In the cleaning process, the temperature of the cleaning water 74 is preferably be a certain temperature level (e.g., 5° C. or higher). That is, the temperature controller 66-4 measures the temperature of the permeate 61 in the permeate tank 71, and when the temperature is higher than a certain temperature level (e.g., 5° C.), the cleaning pump 73 starts up to supply a part of the permeate 61, as the cleaning water 74, to the reverse osmosis membrane system 13 so as to clean the reverse osmosis membranes 63. When the temperature of the permeate 61 in the permeate tank 71 is lower than a certain temperature level (e.g., 5° C.), the heating unit 72 heats the permeate 61 up to a certain temperature level. When the temperature of the permeate 61 rises over a certain temperature level (e.g., 5° C.), the cleaning pump 73 starts up to supply a part of the permeate 61, as the cleaning water 74, to the reverse osmosis membrane system 13 so as to clean the reverse osmosis membranes 63.

The reverse osmosis membranes 63 of the reverse osmosis membrane system 13 should be cleaned periodically (e.g., every three to six months). The cleaning unit 70 in the permeate line L21 is allowed to perform the cleaning of the reverse osmosis membranes 63 of the reverse osmosis membrane system 13.

In the embodiment, a certain temperature level is preferably 5° C. or above, more preferably 10° C. or above, and furthermore preferably 15° C. or above. Note that, the operational temperature is determined project by project, as the temperature range of a certain temperature level depends on environmental conditions where the reverse osmosis membrane system 13 is installed.

A cleaning chemical injection unit 76 for dosing a cleaning chemical 75 to the cleaning water 74 may be provided in the cleaning water supply line L41. Typically well-known chemicals such as oxalic acid, citric acid, and caustic soda may be used as the cleaning chemical 75.

The cleaning chemical supply unit 76 in the cleaning water supply line L41 allows the reverse osmosis membranes 63 to be cleaned by both flushing with the permeate 61 and chemical cleaning with permeate 61 and the cleaning chemical 75.

That is, the seawater desalination system 10A according to the embodiment allows the reverse osmosis membranes 63 of the reverse osmosis membrane system 13 to be cleaned by both flushing with the permeate 61 and chemical cleaning with permeate 61 and the cleaning chemical 75.

### Second Embodiment

A seawater desalination system according to a second embodiment of the present invention will be described referring to the attached drawings. The configuration of the seawater desalination system according to the embodiment is similar to the configuration of the seawater desalination system according to the first embodiment of the present invention illustrated in FIG. 1. Therefore, the components same as those of the seawater desalination system according to the first embodiment are appended with the same legends and symbols, and the system description is omitted.

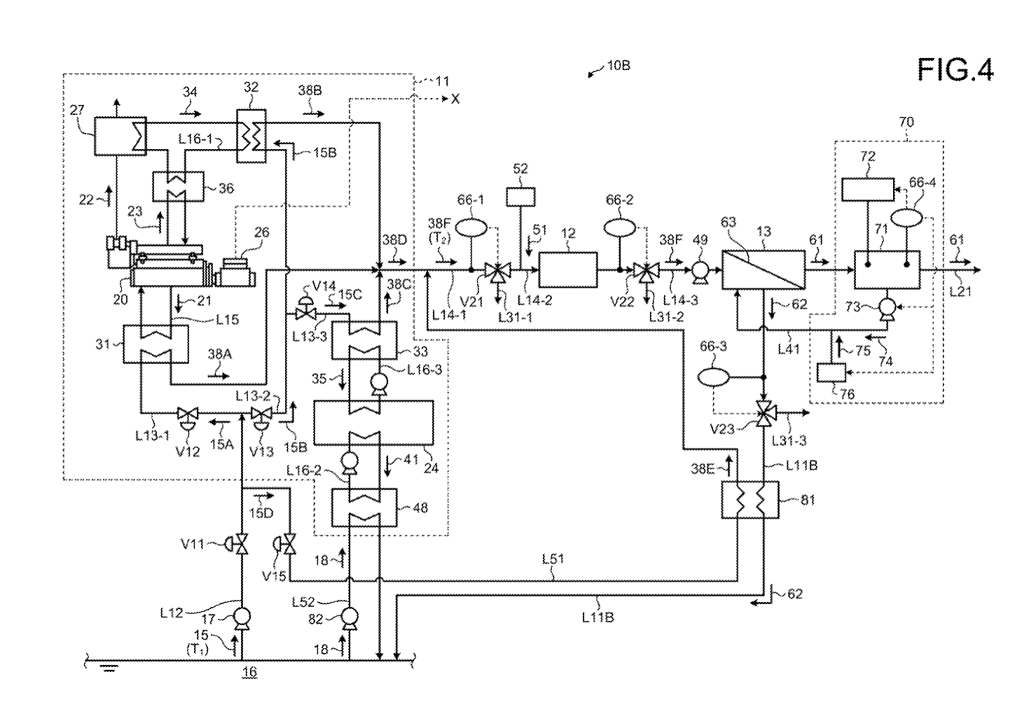

FIG. 4 is a block diagram of the seawater desalination system according to the second embodiment of the present invention. As illustrated in FIG. 4, the seawater desalination system 10B according to the embodiment has the same configuration as the seawater desalination system 10A according to the first embodiment of the present invention illustrated in FIG. 1, except that the seawater desalination system 10B includes a seawater extraction line L51, a sixth heat exchanger 81, and a seawater supply line L52 to the heat exchanger, and that the concentrate 62 is not supplied to the fifth heat exchanger 48 but to the sixth heat exchanger 81 through the second concentrate discharge line L11B.

The seawater extraction line L51 is provided to branch off from the seawater supply line L12. The feed seawater to the reverse osmosis membrane system 15D is extracted from the upstream of the heat exchanging unit 11 and supplied to the downstream of the heat exchanging unit 11 via the seawater extraction line L51. The sixth heat exchanger 81 performs heat exchange between the feed seawater 15D to the reverse osmosis membrane system extracted through the seawater extraction line L51 and the concentrate 62 discharged from the reverse osmosis membrane system 13 to the second concentrate discharge line L11B. The flow rate of the feed seawater 15 to the reverse osmosis membrane system supplied to the seawater extraction line L51 is controlled by a control valve V15.

The feed seawater 15D to the reverse osmosis membrane system extracted from the seawater supply line L12 to the seawater extraction line L51 exchanges heat with the concentrate 62 in the sixth heat exchanger 81, and is then supplied as heated seawater 38E, to the heated seawater supply line L14-1, and is then blended with the heated seawater 38D. The heated seawater 38D blended with the heated seawater 38E is supplied to the pretreatment system 12 as heated seawater 38F.

Further, the concentrate 62 exchanges heat with the feed seawater 15D to the reverse osmosis membrane system in the sixth heat exchanger 81, and is then discharged to the sea 16.

Through the seawater supply line L52 to the heat exchanger, the feed seawater 18 to the heat exchanger pumped up from the sea 16 by a pump 82 is supplied to the fifth exchanger 48 to exchange heat with the third heading medium 41. The feed seawater 18 to the heat exchanger 18 supplied to the seawater supply line L52 to the heat exchanger exchanges heat with the third heating medium 41 in the fifth heat exchanger 48, and is then discharged to the sea 16.

The feed seawater 15C to the reverse osmosis membrane system is supplied to the third heat exchanger 33 via the third seawater branch line L13-3 to exchange heat with the second heating medium 35 in the third heat exchanger 33, and then heated.

In the fifth heat exchanger 48, the third heating medium 41 is heated by exchanging heat with the feed seawater 18 to the heat exchanger. The third heating medium 41 exchanges heat with the cooling medium 47 in the evaporator 42 of the heat pump system 24. The second heating medium 35 heated in the condenser 44 of the heat pump system 24 is supplied to the third heat exchanger 33, and exchanges heat with the feed seawater 15C to the reverse osmosis membrane system which is supplied to the pretreatment system 12. The heated seawater 38C heated by exchanging heat in the third heat exchanger 33 is blended with other heated seawater 38A, 38B, and 38E. The blended heated seawater is supplied, as heated seawater 38F, to the pretreatment system 12 via the heated seawater supply line L14-1.

In this manner, as a result, even when the temperature of the feed seawater 15 to the reverse osmosis membrane system is lower than a certain temperature level (e.g., 5° C.), the feed seawater 15 to the reverse osmosis membrane system 15 can be supplied to the pretreatment system 12 after preheating over a certain temperature level (e.g., 5° C.). Therefore, the seawater desalination system 10B according to the embodiment can provide pretreatment operation in economical and stable manners, even in such marine conditions as lower seawater temperature, by efficient heating and control of the seawater. Further, even when the temperature of the feed seawater 15 to the reverse osmosis membrane system is lower than a certain temperature level (e.g., 5° C.), the feed seawater 15 to the reverse osmosis membrane system can be heated over a certain temperature level (e.g., 5° C.) and then supplied to the reverse osmosis membrane system 13. Consequently, the seawater desalination system 10B according to the embodiment is allowed to produce permeate 61 in economical and stable manners, even in such marine conditions as lower seawater temperature, by efficient heating and control of the seawater.

Further, the sweater desalination system 10B according to the embodiment applies the method for heating feed seawater 15 to the reverse osmosis membrane system in the heat exchanging unit 11, by using the thermal energy of the thermal discharge, the steam, and the exhaust gas generated through the gas engine 20, and by using the thermal energy of low-temperature feed seawater 18 to the heat exchanger recovered from the heat pump system 24, that is, the potential thermal energy of the bulk seawater. Consequently, the embodiment is allowed to provide an optimum seawater desalination system in compliance with site constraints, environmental conditions, or the like where the seawater desalination system is installed.

### Third Embodiment

A seawater desalination system according to a third embodiment of the present invention will be described referring to the attached drawings. The configuration of the seawater desalination system according to the embodiment is similar to configurations of seawater desalination systems according to the first and second embodiments of the present invention illustrated in FIGS. 1 and 4. Therefore, the components same as those of seawater desalination systems according to the first and second embodiments are appended with the same reference legends and symbols, and the system description is omitted.

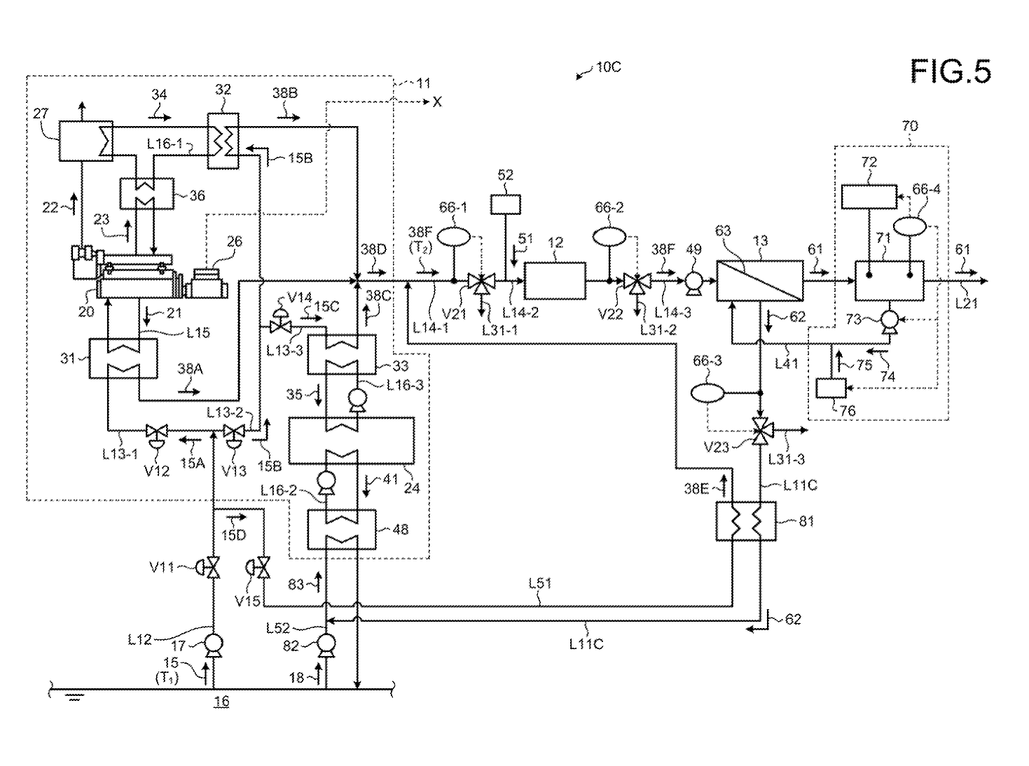

FIG. 5 is a block diagram of a seawater desalination system according to a second embodiment of the present invention. As illustrated in FIG. 5, the seawater desalination system 10C according to the embodiment has the same configuration as the seawater desalination system 10B according to the second embodiment illustrated in FIG. 4 except that the second concentrate discharge line L11C is connected to the seawater supply line L52 to the heat exchanger.

The second concentrate discharge line L11C is connected to the seawater supply line L52 to the heat exchanger. In this manner, through the seawater supply line L52 to the heat exchanger, the blended water 83, which is the mixture of the feed seawater 18 to the heat exchanger pumped up from the sea 16 by the pump 82 and the concentrate 62, is supplied to the fifth heat exchanger 48 to exchange heat with the third heating medium 41.

The blended water 83 exchanges heat with the third heating medium 41 in the fifth heat exchanger 48, and is then discharged to the sea 16.

In the fifth heat exchanger 48, the third heating medium 41 is heated by exchanging heat with the blended water 83 which is the mixture of the concentrate 62 and the feed seawater to heat exchanger 18. The third heating medium 41 exchanges heat with the cooling medium 47 in the evaporator 42 of the heat pump system 24. The second heating medium 35 heated in the condenser 44 of the heat pump system 24 is supplied to the third heat exchanger 33, and exchanges heat with the feed seawater 15C to the reverse osmosis membrane system which is supplied to the pretreatment system 12. The heated seawater 38C heated by exchanging heat in the third heat exchanger 33 is blended with other heated seawater 38A, 38B, and 38E. The blended heated seawater is supplied as heated seawater 38F to the pretreatment system 12 via the heated seawater supply line L14-1.

In this manner, as a result, even when the temperature of the feed seawater 15 to the reverse osmosis membrane system is lower than a certain temperature level (e.g., 5° C.), the feed seawater 15 to the reverse osmosis membrane system 15 can be supplied to the pretreatment system 12 after preheating over a certain temperature level (e.g., 5° C.) Therefore, the seawater desalination system 10C according to the embodiment can provide pretreatment operation in economical and stable manners, even in such marine conditions as lower seawater temperature, by efficient heating and control of the seawater. Further, even when the temperature of the feed seawater 15 to the reverse osmosis membrane system is lower than a certain temperature level (e.g., 5° C.), the feed seawater 15 to the reverse osmosis membrane system can be heated over a certain temperature level (e.g., 5° C.) and then supplied to the reverse osmosis membrane system 13. Consequently, the seawater desalination system 10C according to the embodiment is allowed to produce permeate 61 in economical and stable manners, even in such marine conditions as lower seawater temperature, by efficient heating and control of the seawater.

### Fourth Embodiment

A seawater desalination system according to a fourth embodiment of the present invention will be described referring to the attached drawings. The configuration of the seawater desalination system according to the embodiment is similar to the configuration of the seawater desalination system according to the first embodiment of the present invention illustrated in FIG. 1. Therefore, the components same as those of the seawater desalination system according to the first embodiment are appended with the same legends and symbols, and the system description is omitted.

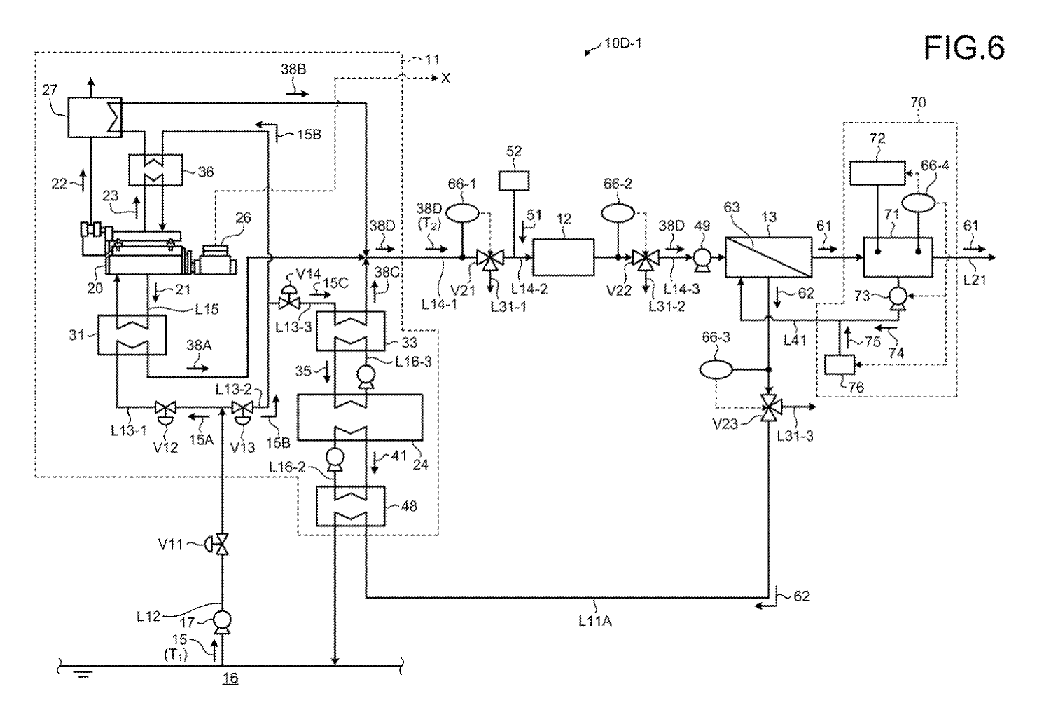

FIG. 6 is a block diagram of a seawater desalination system according to the fourth embodiment of the present invention. As illustrated in FIG. 6, the seawater desalination system 10D-1 according to the embodiment has the same configuration as the seawater desalination system 10A according to the first embodiment illustrated in FIG. 1 except that, instead of performing indirect heat exchange of the exhaust gas 22 and the steam 23 with the feed seawater 15B to the reverse osmosis membrane system in the second heat exchanger 32 via the first heating medium 34, as illustrated in FIG. 1 of the seawater desalination system 10A in the first embodiment, the feed seawater 15B to the reverse osmosis membrane system directly exchanges heat through the fourth heat exchanger 36 and the exhaust gas boiler 27, without using a heating medium.

As illustrated in FIG. 6, the fourth heat exchanger 36 performs heat exchange between the steam 23 generated through the gas engine 20 and the feed seawater 15B to the reverse osmosis membrane system, and the exhaust gas boiler 27 performs heat exchange between the exhaust gas 22 generated through the gas engine 20 and the feed seawater 15B to the reverse osmosis membrane system. The second seawater branch line L13-2 is arranged so that heat exchange can be performed with the exhausted gas 22 and the steam 23 in the exhaust gas boiler 27 and the fourth heat exchanger 36. The feed seawater 15B to the reverse osmosis membrane system is supplied to the fourth heat exchanger 36 via the second seawater branch line L13-2 to exchange heat with the steam 23 generated through the gas engine 20, and heated in the fourth heat exchanger 36. After heated by exchanging heat in the fourth heat exchanger 36, the feed seawater 15B to the reverse osmosis membrane system is supplied to the exhaust gas boiler 27 to exchange heat with the exhaust gas 22, and further heated.

After heated by exchanging heat in the fourth heat exchanger 36 and the exhaust gas boiler 27, the feed seawater 15B to the reverse osmosis membrane system as heated seawater 38B is blended with heated seawater 38A and 38C and supplied to the heated seawater supply line L14-1. The blended heated seawater is then supplied to the pretreatment system 12 as heated seawater 38D.

In this manner, as a result, even when the temperature of the feed seawater 15 to the reverse osmosis membrane system is lower than a certain temperature level (e.g., 5° C.), the feed seawater 15 to the reverse osmosis membrane system 15 can be supplied to the pretreatment system 12 after preheating over a certain temperature level (e.g., 5° C.)

Therefore, the seawater desalination system 10D-1 according to the embodiment can provide pretreatment operation in economical and stable manners, even in such marine conditions as lower seawater temperature, by efficient heating and control of the seawater. Further, even when the temperature of the feed seawater 15 to the reverse osmosis membrane system is lower than a certain temperature level (e.g., 5° C.), the feed seawater 15 to the reverse osmosis membrane system can be heated over a certain temperature level (e.g., 5° C.) and then supplied to the reverse osmosis membrane system 13. Consequently, the seawater desalination system 10D-1 according to the embodiment is allowed to produce permeate 61 in economical and stable manners, even in such marine conditions as lower seawater temperature, by efficient heating and control of the seawater.

In the embodiment, the description is made for the configuration in which, instead of performing indirect heat exchange of the exhausted gas 22 and the steam 23 with the feed seawater 15B to the reverse osmosis membrane system, as illustrated in FIG. 1 of the seawater desalination system 10A in the first embodiment, the exhaust gas 22 and the steam 23 directly exchange heat with the feed seawater 15B to the reverse osmosis membrane system. However, the embodiment is not limited to the configuration. The configuration described above can be also applied to the seawater desalination system 10B of the second embodiment illustrated in FIG. 4 and the seawater desalination system 10C of the third embodiment illustrated in FIG. 5.

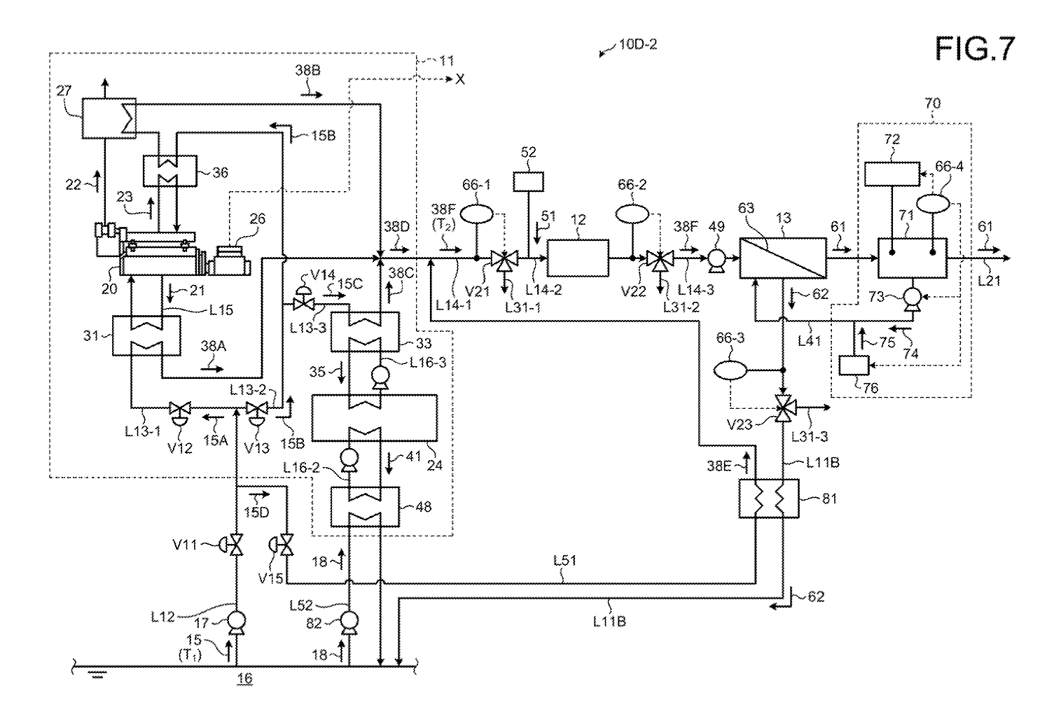

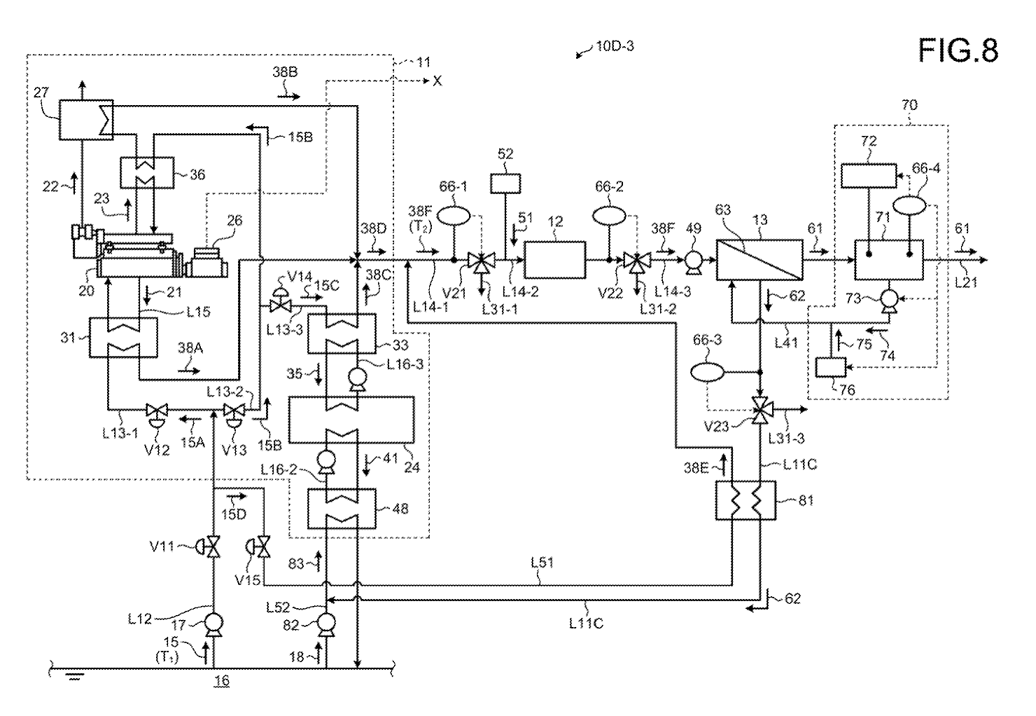

FIGS. 7 and 8 illustrate alternative configurations of the seawater desalination system according to the embodiment. As illustrated in FIG. 7, the seawater desalination system 10D-2 according to the embodiment is configured that, instead of performing indirect heat exchange of the exhaust gas 22 and the steam 23 with the feed seawater 15B to the reverse osmosis membrane system in the second heat exchanger 32 via the first heating medium 34, as illustrated in FIG. 4 of the seawater desalination system 10B in the second embodiment, the feed seawater 15B to the reverse osmosis membrane system directly exchanges heat through the fourth heat exchanger 36 and the exhaust gas boiler 27, without using a heating medium. Further, as illustrated in FIG. 8, the seawater desalination system 10D-3 according to the embodiment is configured that, instead of performing indirect heat exchange of the exhaust gas 22 and the steam 23 with the feed seawater 15B to the reverse osmosis membrane system in the second heat exchanger 32 via the first heating medium 34, as illustrated in FIG. 5 of the seawater desalination system 10C in the third embodiment, the feed seawater 15B to the reverse osmosis membrane system directly exchanges heat through the fourth heat exchanger 36 and the exhaust gas boiler 27, without using a heating medium.

In this manner, as a result, even when the temperature of the feed seawater 15 to the reverse osmosis membrane system is lower than a certain temperature level (e.g., 5° C.), the feed seawater 15 to the reverse osmosis membrane system 15 can be supplied to the pretreatment system 12 after preheating over a certain temperature level (e.g., 5° C.) Therefore, the seawater desalination system 10D-2 and 10D-3 according to the embodiment can provide pretreatment operation in economical and stable manners, even in such marine conditions as lower seawater temperature, by efficient heating and control of the seawater. Further, even when the temperature of the feed seawater 15 to the reverse osmosis membrane system is lower than a certain temperature level (e.g., 5° C.), the feed seawater 15 to the reverse osmosis membrane system can be heated over a certain temperature level (e.g., 5° C.) and then supplied to the reverse osmosis membrane system 13. Consequently, the seawater desalination system 10D-2 and 10D-3 according to the embodiment is allowed to produce permeate 61 in economical and stable manners, even in such marine conditions as lower seawater temperature, by efficient heating and control of the seawater.

### Fifth Embodiment

A seawater desalination system according to a fifth embodiment of the present invention will be described referring to the attached drawings. The configuration of the seawater desalination system according to the embodiment is similar to the configuration of the seawater desalination system according to the first embodiment of the present invention illustrated in FIG. 1. Therefore, the components same as those of the seawater desalination system according to the first embodiment are appended with the same legends and symbols, and the system description is omitted.

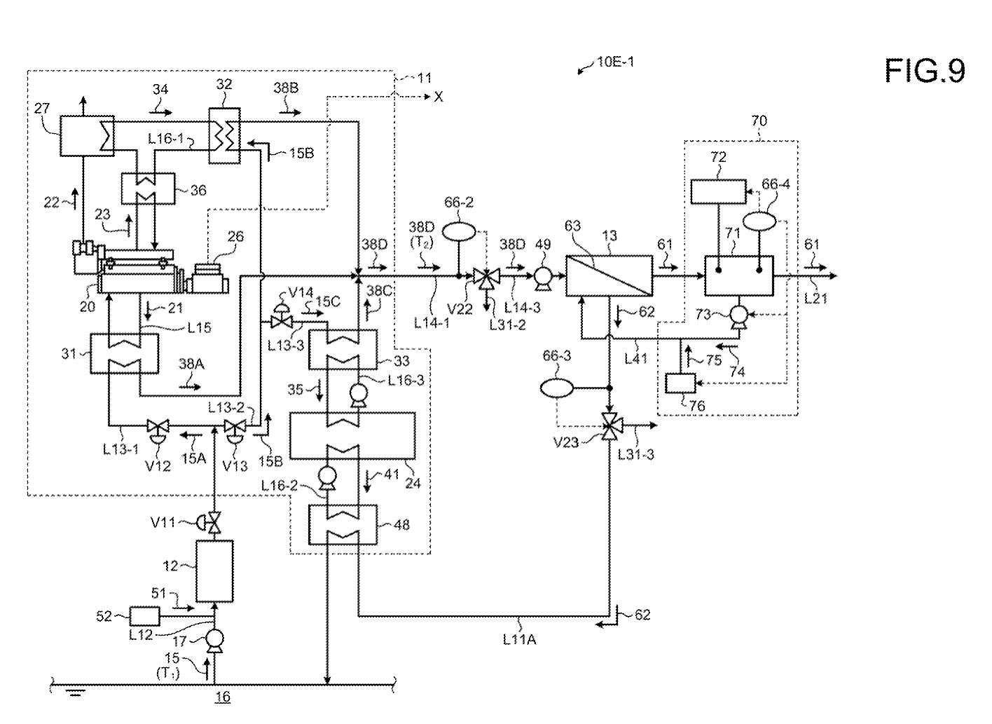

FIG. 9 is a block diagram of a seawater desalination system according to the fifth embodiment of the present invention. As illustrated in FIG. 9, the seawater desalination system 10E-1 according to the embodiment has the same configuration as the seawater desalination system 10A according to the first embodiment illustrated in FIG. 1, except that the pretreatment system 12 and the coagulant and/or flocculant injection unit 52 in the seawater desalination system 10A of the first embodiment illustrated in FIG. 1 is provided in the upstream of the heat exchanging unit 11. Note that, in the embodiment, since the pretreatment system 12 is provided in the upstream of the heat exchanging unit 11, no temperature controller 66-1, switching valve V21, and seawater discharge line L31-1 illustrated in FIG. 1 are provided.

In the seawater desalination system 10E-1 according to the embodiment, the pretreatment system 12 is provided in the upstream of the heat exchanging unit 11. The feed seawater 15 to the reverse osmosis membrane system pumped up from the sea 16 is supplied to the pretreatment system 12 via the seawater supply line L12. The suspended matters contained in the feed seawater 15 to the reverse osmosis membrane system are removed in the pretreatment system 12. Then the feed seawater 15 to the reverse osmosis membrane system after treatment in the pretreatment system 12 is supplied to the heat exchanging unit 11 for heating, and then supplied to the reverse osmosis membrane system 13 to produce the permeate 61.

In the seawater desalination system 10E-1 of the embodiment, since the pretreatment system 12 is provided in the upstream of the heat exchanging unit 11, the suspended matters contained in the feed seawater to the reverse osmosis membrane system 15 can previously be removed in the pretreatment system 12, so that clarified feed seawater 15 to the reverse osmosis membrane system can be supplied to the heat exchanging unit 11. Accordingly, clogging, scaling, or the like in the heat exchangers and pipes integrated in the heat exchanging unit 11 is prevented, so that reliability and availability of the seawater desalination system 10E-1 can be improved. Further, in the seawater desalination system 10E-1 of the embodiment, since the pretreatment system 12 is provided in the upstream of the heat exchanging unit 11, the amount of seawater supplied to the heat exchanging unit 11 can be reduced by the amount of the washing water in the pretreatment system 12. Consequently, the amount of heat exchanged in the heat exchanging unit 11 can be reduced, allowing the seawater desalination system 10E-1 to save energy.

In the embodiment, the description is made for the configuration in which, instead of providing the heat exchanging unit 11 and the pretreatment system 12 in this order along the flow direction of the feed seawater 15 to the reverse osmosis membrane system 15, as illustrated in FIG. 1 of the seawater desalination system 10A in the first embodiment, the pretreatment system 12 is provided in the upstream of the heat exchanging unit 11. However, the embodiment is not limited to the configuration. The configuration described above can similarly be also applied to the seawater desalination system 10B of the second embodiment illustrated in FIG. 4, the seawater desalination system 10C of the third embodiment illustrated in FIG. 5, and the seawater desalination systems 10D-1 to 10D-3 of the fourth embodiment illustrated in FIG. 6 to FIG. 8.

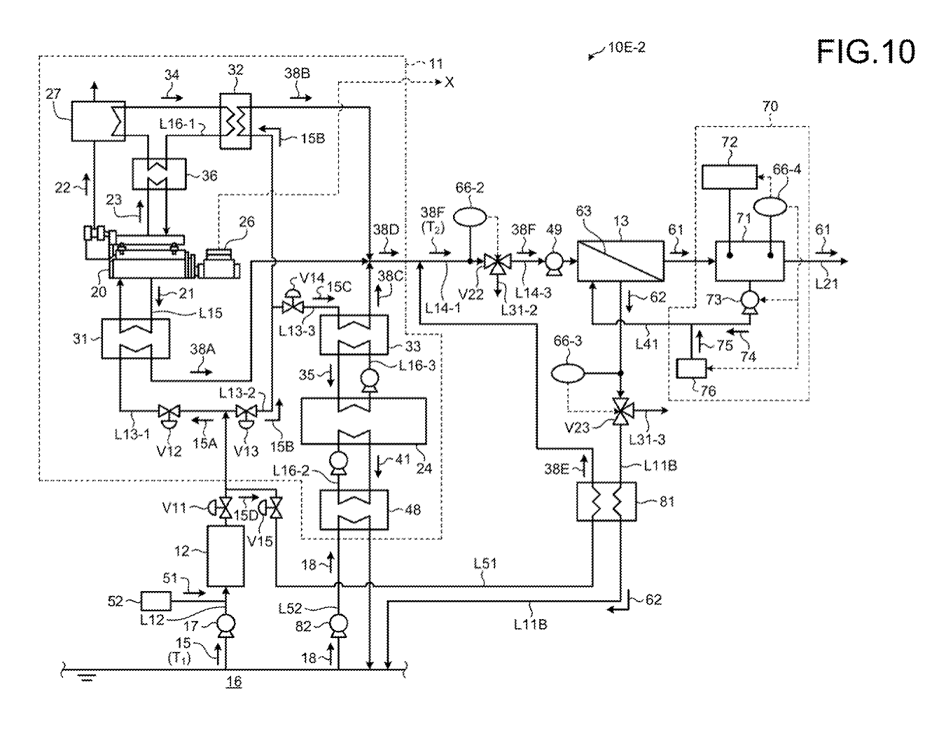

FIG. 10 to FIG. 14 illustrate alternative configurations of the seawater desalination system according to the embodiment. As illustrated in FIG. 10, the seawater desalination system 10E-2 according to the embodiment is configured that, instead of providing the pretreatment system 12 in the downstream of the heat exchanging unit 11, as illustrated in FIG. 4 of the seawater desalination system 10B in the second embodiment, the pretreatment system 12 is provided in the upstream of the heat exchanging unit 11.

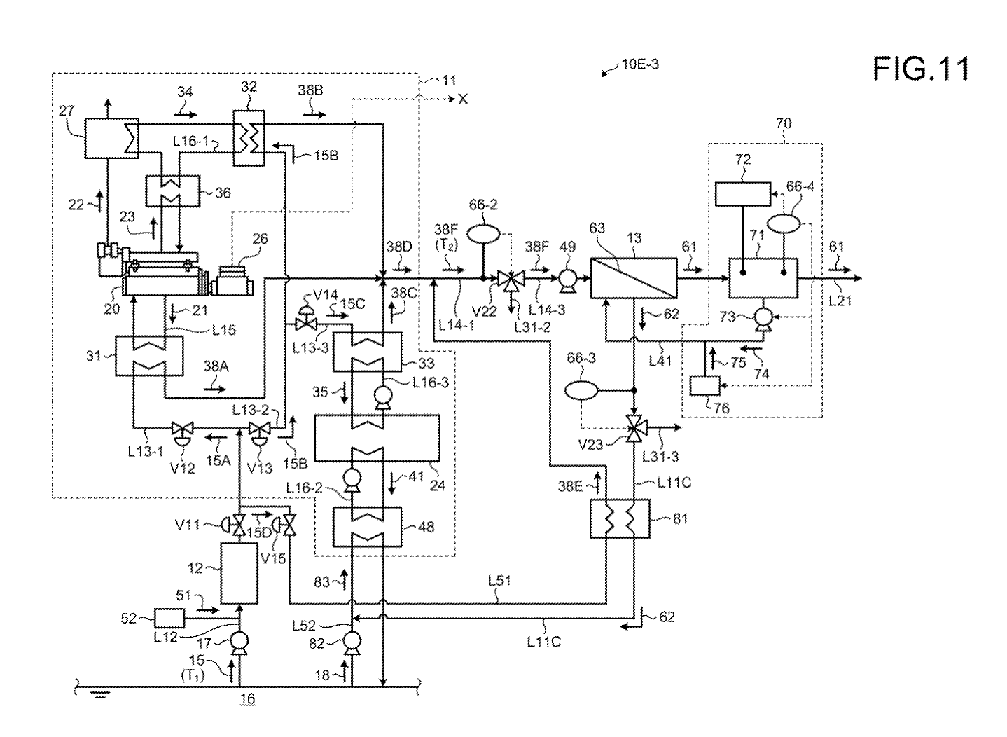

Further, as illustrated in FIG. 11, the seawater desalination system 10E-3 according to the embodiment is configured that, instead of providing the pretreatment system 12 in the downstream of the heat exchanging unit 11, as illustrated in FIG. 5 of the seawater desalination system 10C in the third embodiment, the pretreatment system 12 is provided in the upstream of the heat exchanging unit 11.

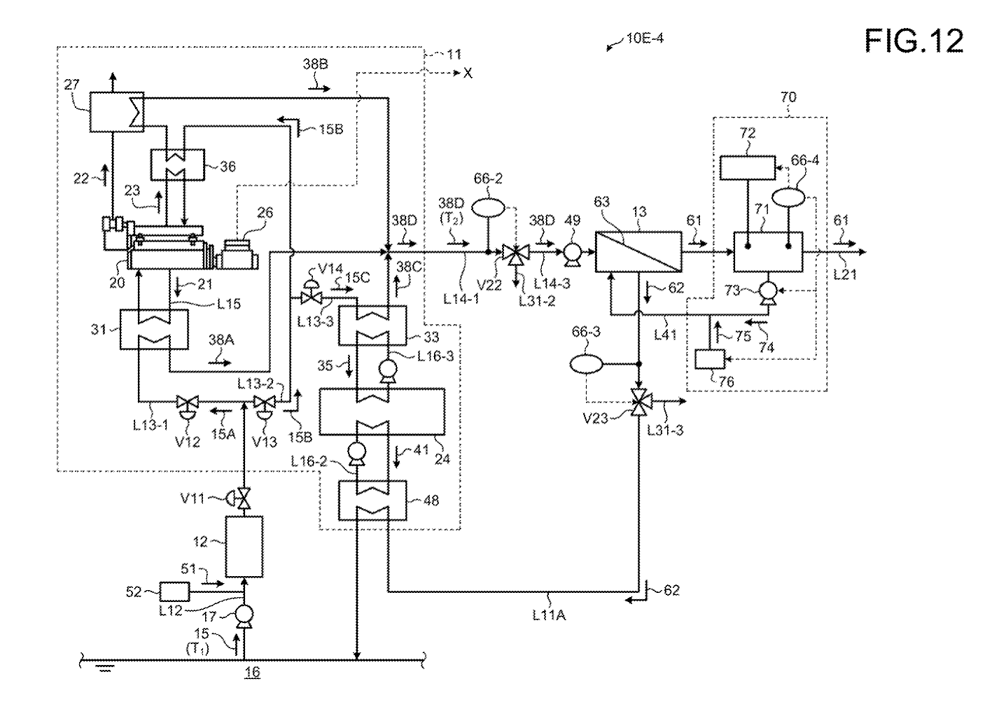

Further, as illustrated in FIG. 12, the seawater desalination system 10E-4 according to the embodiment is configured that, instead of providing the pretreatment system 12 in the downstream of the heat exchanging unit 11, as illustrated in FIG. 6 of the seawater desalination system 10D-1 in the fourth embodiment, the pretreatment system 12 is provided in the upstream of the heat exchanging unit 11.

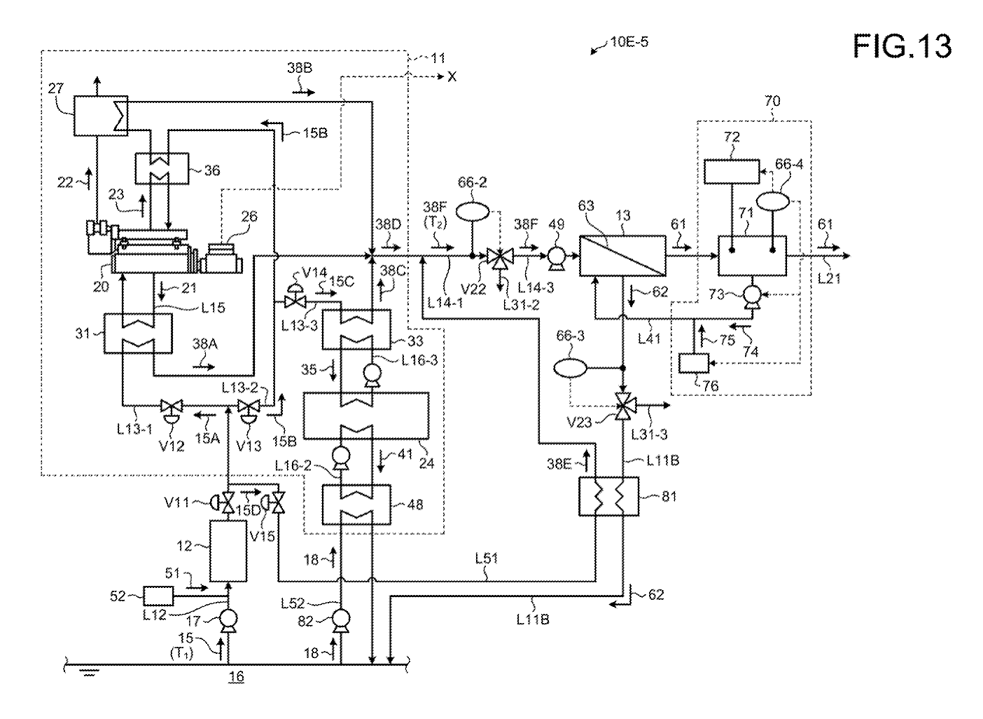

Further, as illustrated in FIG. 13, the seawater desalination system 10E-5 according to the embodiment is configured that, instead of providing the pretreatment system 12 in the downstream of the heat exchanging unit 11, as illustrated in FIG. 7 of the seawater desalination system 10D-2 in the fourth embodiment, the pretreatment system 12 is provided in the upstream of the heat exchanging unit 11.

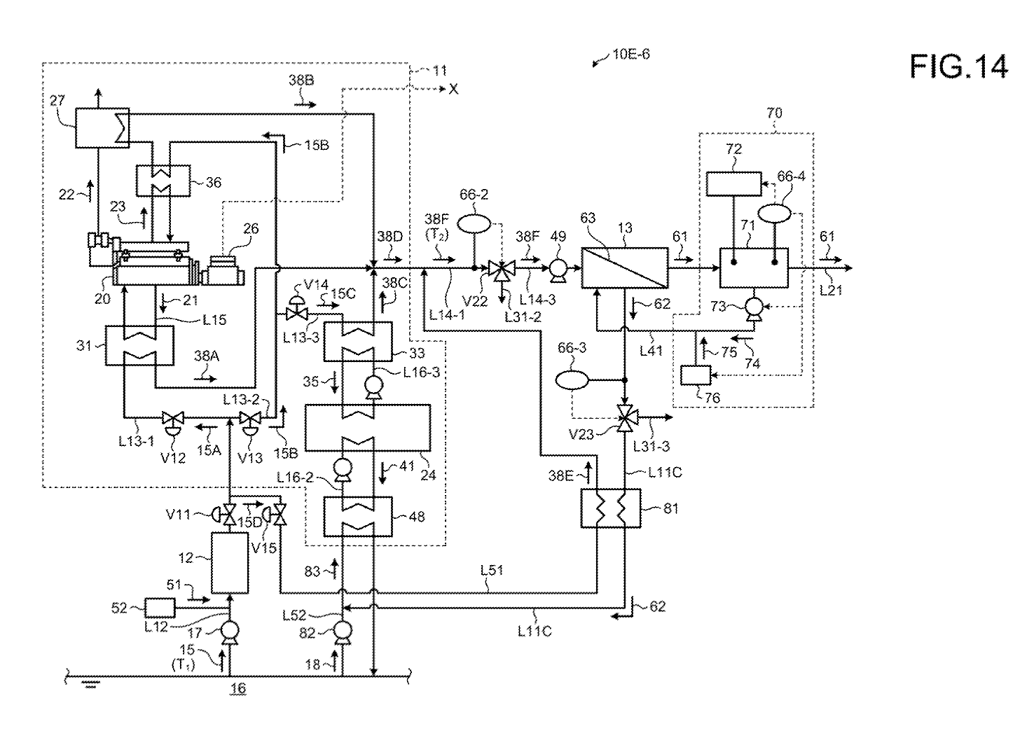

Further, as illustrated in FIG. 14, the seawater desalination system 10E-6 according to the embodiment is configured that, instead of providing the pretreatment system 12 in the downstream of the heat exchanging unit 11, as illustrated in FIG. 8 of the seawater desalination system 10D-3 in the fourth embodiment, the pretreatment system 12 is provided in the upstream of the heat exchanging unit 11.

In the seawater desalination systems 10E-2 to 10E-6 of the embodiment as illustrated in FIG. 10 to FIG. 14, since the pretreatment system 12 is provided in the upstream of the heat exchanging unit 11, the suspended matters in the feed seawater 15 to the reverse osmosis membrane system can previously be removed in the pretreatment system 12, so that the clarified seawater 15 to the reverse osmosis membrane system can be supplied to the heat exchanging unit 11. Accordingly, also in the seawater desalination systems 10E-2 to 10E-6 according to the embodiment, clogging, scaling, or the like in the heat exchangers and pipes integrated in the heat exchanging unit 11 is prevented, so that reliability and availability of seawater desalination systems 10E-2 to 10E-6 can be improved. Further, in the seawater desalination systems 10E-2 to 10E-6 of the embodiment, since the pretreatment system 12 is provided in the upstream of the heat exchanging unit 11, the amount of seawater supplied to the heat exchanging unit 11 can be reduced by the amount of the washing water in the pretreatment system 12. Consequently, the amount of heat exchanged in the heat exchanging unit 11 can be reduced, allowing the seawater desalination systems 10E-2 to 10E-6 to save energy.

As described above, the desalination system using the reverse osmosis membrane technology to produce fresh water from seawater is explained for the seawater desalination systems 10A to 10E-6 according to the embodiment. However, the embodiment is not limited to the configuration. The desalination system may be applied to other water sources than seawater, for example, brackish water. Further, the invention can similarly be applied to the reverse osmosis membrane system, including not only desalination system, but also ultrapure water production system, water treatment system, drainage treatment system, sewage treatment system, wastewater treatment system, and other type of water treatment systems.

### REFERENCE LEGENDS LIST

10A, 10B, 10C, 10D-1 to 10D-3, 10E-1 to 10E-6
12 seawater desalination system
11 heat exchanging unit
12 pretreatment system
13 reverse osmosis membrane system
15, 15A to 15D feed seawater to the reverse osmosis membrane system
16 sea
17, 82 pump
18 feed seawater to the heat exchanger
20 gas engine
21 thermal discharge
22 exhaust gas
23 steam
24 heat pump system
26 generator
27 exhaust gas boiler
31 first heat exchanger
32 second heat exchanger
33 third heat exchanger
34 first heating medium
35 second heating medium
36 fourth heat exchanger
38A, 38B, 38C, 38D, 38E, 38F heated seawater
41 third heating medium
42 evaporator
43 compressor
44 condenser
45 expansion valve
46 piping
47 cooling medium
48 fifth heat exchanger
49 booster pump
51 coagulant and/or flocculant
52 coagulant and/or flocculant injection unit
61 permeate
62 concentrate
63 reverse osmosis membranes (RO membranes)
66-1, 66-2, 66-3, 66-4 temperature controller (TC)
70 cleaning unit
71 permeate tank
72 heating unit (heater)
73 cleaning pump
74 cleaning water
75 cleaning chemical
76 cleaning chemical supply unit
81 sixth heat exchanger
83 blended water
L11A first concentrate discharge line
L11B, L11C second concentrate discharge line
L12 seawater supply line
L13-1 first seawater branch line
L13-2 second seawater branch line
L13-3 third seawater branch line
L14-1 to L14-3 heated seawater supply line
L15 drainage water circulation line
L16-1 to L16-3 heating medium circulation line
L21 permeate line
L31-1 to L31-2 seawater discharge line
L31-3 concentrate discharge line
L41 cleaning water supply line
L51 seawater extraction line
L52 seawater supply line to the heat exchanger
V11 to V14 control valve
V21 to V23 switching valve
X each unit requiring power supply

1. A seawater desalination system comprising:
a heat exchanging unit for heating feed seawater to a reverse osmosis membrane system using at least one or more of thermal discharge, exhaust gas, and steam generated through a gas engine and heating medium used in a heat pump system; and
a reverse osmosis membrane system that is provided at the downstream of the heat exchanging unit and separates the feed seawater to the reverse osmosis membrane system into permeate and concentrate.

2. The seawater desalination system according to claim 1, wherein the heat exchanging unit includes a first heat exchanger for performing heat exchange between the feed seawater to the reverse osmosis membrane system and the thermal discharge generated through the gas engine, the feed seawater to the reverse osmosis membrane system being supplied via a first seawater branch line branched off from a seawater supply line for supplying the feed seawater to the reverse osmosis membrane system to the reverse osmosis membrane system, and
a third heat exchanger for performing heat exchange between a second heating medium exchanged heat with a cooling medium circulating the heat pump system and the feed seawater to reverse osmosis membrane system,
wherein the feed seawater to the reverse osmosis membrane system supplied via a second seawater branch line branched off from the seawater supply line is directly heated in the second seawater branch line by using the exhaust gas and the steam as heat sources, or indirectly heated by using a first heating medium exchanged heat with the exhaust gas and the steam, and
wherein a first concentrate discharge line for supplying the concentrate to a fifth heat exchanger performing heat exchange between a third heating medium, exchanged heat with the cooling medium circulating the heat pump system, and the concentrate, and then discharging the concentrate to sea.

3. The seawater desalination system according to claim 1,
wherein the heat exchanging unit includes a first heat exchanger for performing heat exchange between the feed seawater to the reverse osmosis membrane system supplied via a first seawater branch line branched off from a seawater supply line for supplying the feed seawater to the reverse osmosis membrane system to the reverse osmosis membrane system and the thermal discharge generated through the gas engine, and
a third heat exchanger for performing heat exchange between a second heating medium exchanged heat with a cooling medium circulating the heat pump system and the feed seawater to the reverse osmosis membrane system, and
wherein the feed seawater to the reverse osmosis membrane system supplied via a second seawater branch line branched off from the seawater supply line is directly heated in the second seawater branch line by using the exhaust gas and the steam as heat sources, or indirectly heated by using a first heating medium exchanged heat with the exhaust gas and the steam,
the system further comprising:
a seawater supply line to heat exchanger for supplying feed seawater to the heat exchanger to a fifth heat exchanger;
a seawater extraction line for extracting the feed seawater to the reverse osmosis membrane system from the upstream of the heat exchanging unit and supplying the extracted feed seawater to the reverse osmosis membrane system to the downstream of the heat exchanging unit; and
a sixth heat exchanger for performing heat exchange between the feed seawater to the reverse osmosis membrane system extracted into the seawater extraction line and the concentrate in a second concentrate discharge line for discharging the concentrate from the reverse osmosis membrane system to the sea.

4. The seawater desalination system according to claim 3, wherein the second concentrate discharge line and the seawater supply line to heat exchanger are connected.

5. The seawater desalination system according to claim 1, further comprising:
a pretreatment system for removing suspended matters contained in the feed seawater to the reverse osmosis membrane system, the pretreatment system being provided in the upstream or the downstream of the heat exchanging unit;
a switching valve for switching a stream of the feed seawater to the reverse osmosis membrane system and a temperature controller for measuring temperature of the feed seawater to the reverse osmosis membrane system to control the switching valve, the switching valve and the temperature controller being provided in either of, or both of, a section between the heat exchanging unit and the pretreatment system and a section in the downstream of the pretreatment system and the heat exchanging unit but in the upstream of the reverse osmosis membrane system,
wherein the temperature controller controls the switching valve according to temperature of the feed seawater to the reverse osmosis membrane system to switch a stream of the feed seawater to the reverse osmosis membrane system.

6. The seawater desalination system according to claim 1, further comprising a switching valve for switching a stream of the concentrate and a temperature controller for measuring temperature of the concentrate to control the switching valve,
wherein the temperature controller controls the switching valve according to temperature of the concentrate to switch a stream of the concentrate.

7. The seawater desalination system according to claim 1, further comprising a cleaning unit for cleaning reverse osmosis membranes of the reverse osmosis membrane system, the cleaning unit being provided in the downstream of the reverse osmosis membrane system,
wherein the cleaning unit includes a permeate tank for storing the permeate, a cleaning pump for supplying the permeate in the permeate tank to the reverse osmosis membranes of the reverse osmosis membrane system, a heating unit for heating the permeate in the permeate tank, and a temperature controller for measuring the temperature of the permeate in the permeate tank to control the heating unit, and
wherein the temperature controller controls the heating unit, according to a temperature of the permeate in the permeate tank, to heat the permeate, or control the cleaning pump to supply the permeate to the reverse osmosis membrane system.

8. The seawater desalination system according to claim 1, further comprising a coagulant and/or flocculant injection unit for supplying a coagulant and/or flocculant to coagulate suspended matters contained in the feed seawater to the reverse osmosis membrane system, the coagulant and/or flocculant injection unit being provided in the upstream of the pretreatment system.

9. The seawater desalination system according to claim 1, wherein the heat exchanging unit heats the feed seawater to the reverse osmosis membrane system to be in a range from 5° C. to 30° C.

10. The seawater desalination system according to claim 2, further comprising:
a pretreatment system for removing suspended matters contained in the feed seawater to the reverse osmosis membrane system, the pretreatment system being provided in the upstream or the downstream of the heat exchanging unit;
a switching valve for switching a stream of the feed seawater to the reverse osmosis membrane system and a temperature controller for measuring temperature of the feed seawater to the reverse osmosis membrane system to control the switching valve, the switching valve and the temperature controller being provided in either of, or both of, a section between the heat exchanging unit and the pretreatment system and a section in the downstream of the pretreatment system and the heat exchanging unit but in the upstream of the reverse osmosis membrane system,
wherein the temperature controller controls the switching valve according to temperature of the feed seawater to the reverse osmosis membrane system to switch a stream of the feed seawater to the reverse osmosis membrane system.

11. The seawater desalination system according to claim 3, further comprising:
a pretreatment system for removing suspended matters contained in the feed seawater to the reverse osmosis membrane system, the pretreatment system being provided in the upstream or the downstream of the heat exchanging unit;
a switching valve for switching a flow passage of the feed seawater to the reverse osmosis membrane system and a temperature controller for measuring temperature of the feed seawater to the reverse osmosis membrane system to control the switching valve, the switching valve and the temperature controller being provided in either of, or both of, a section between the heat exchanging unit and the pretreatment system and a section in the downstream of the pretreatment system and the heat exchanging unit but in the upstream of the reverse osmosis membrane system,
wherein the temperature controller controls the switching valve according to temperature of the feed seawater to the reverse osmosis membrane system to switch a stream of the feed seawater to the reverse osmosis membrane system.

12. The seawater desalination system according to claim 4, further comprising:
a pretreatment system for removing suspended matters contained in the feed seawater to the reverse osmosis membrane system, the pretreatment system being provided in the upstream or the downstream of the heat exchanging unit;
a switching valve for switching a stream of the feed seawater to the reverse osmosis membrane system and a temperature controller for measuring temperature of the feed seawater to the reverse osmosis membrane system to control the switching valve, the switching valve and the temperature controller being provided in either of, or both of, a section between the heat exchanging unit and the pretreatment system and a section in the downstream of the pretreatment system and the heat exchanging unit but in the upstream of the reverse osmosis membrane system,
wherein the temperature controller controls the switching valve according to temperature of the feed seawater to the reverse osmosis membrane system to switch a stream of the feed seawater to the reverse osmosis membrane system.

13. The seawater desalination system according to claim 2, further comprising a switching valve for switching a stream of the concentrate and a temperature controller for measuring temperature of the concentrate to control the switching valve,
wherein the temperature controller controls the switching valve according to temperature of the concentrate to switch a stream of the concentrate.

14. The seawater desalination system according to claim 3, further comprising a switching valve for switching a stream of the concentrate and a temperature controller for measuring temperature of the concentrate to control the switching valve,
wherein the temperature controller controls the switching valve according to temperature of the concentrate to switch a stream of the concentrate.

15. The seawater desalination system according to claim 4, further comprising a switching valve for switching a stream of the concentrate and a temperature controller for measuring temperature of the concentrate to control the switching valve,
wherein the temperature controller controls the switching valve according to temperature of the concentrate to switch a stream of the concentrate.

16. The seawater desalination system according to claim 2, further comprising a cleaning unit for cleaning reverse osmosis membranes of the reverse osmosis membrane system, the cleaning unit being provided in the downstream of the reverse osmosis membrane system,
wherein the cleaning unit includes a permeate tank for storing the permeate, a cleaning pump for supplying the permeate in the permeate tank to the reverse osmosis membranes of the reverse osmosis membrane system, a heating unit for heating the permeate in the permeate tank, and a temperature controller for measuring the temperature of the permeate in the permeate tank to control the heating unit, and
wherein the temperature controller controls the heating unit, according to a temperature of the permeate in the permeate tank, to heat the permeate, or control the cleaning pump to supply the permeate to the reverse osmosis membrane system.

17. The seawater desalination system according to claim 3, further comprising a cleaning unit for cleaning reverse osmosis membranes of the reverse osmosis membrane system, the cleaning unit being provided in the downstream of the reverse osmosis membrane system,
wherein the cleaning unit includes a permeate tank for storing the permeate, a cleaning pump for supplying the permeate in the permeate tank to the reverse osmosis membranes of the reverse osmosis membrane system, a heating unit for heating the permeate in the permeate tank, and a temperature controller for measuring the temperature of the permeate in the permeate tank to control the heating unit, and
wherein the temperature controller controls the heating unit, according to a temperature of the permeate in the permeate tank, to heat the permeate, or control the cleaning pump to supply the permeate to the reverse osmosis membrane system.

18. The seawater desalination system according to claim 4, further comprising a cleaning unit for cleaning reverse osmosis membranes of the reverse osmosis membrane system, the cleaning unit being provided in the downstream of the reverse osmosis membrane system,
wherein the cleaning unit includes a permeate tank for storing the permeate, a cleaning pump for supplying the permeate in the permeate tank to the reverse osmosis membranes of the reverse osmosis membrane system, a heating unit for heating the permeate in the permeate tank, and a temperature controller for measuring the temperature of the permeate in the permeate tank to control the heating unit, and
wherein the temperature controller controls the heating unit, according to a temperature of the permeate in the permeate tank, to heat the permeate, or control the cleaning pump to supply the permeate to the reverse osmosis membrane system.

19. The seawater desalination system according to claim 2, further comprising a coagulant and/or flocculant injection unit for supplying a coagulant and/or flocculant to coagulate suspended matters contained in the feed seawater to the reverse osmosis membrane system, the coagulant and/or flocculant injection unit being provided in the upstream of the pretreatment system.

20. The seawater desalination system according to claim 3, further comprising a coagulant and/or flocculant injection unit for supplying a coagulant and/or flocculant to coagulate suspended matters contained in the feed seawater to the reverse osmosis membrane system, the coagulant and/or flocculant injection unit being provided in the upstream of the pretreatment system.
